(19) United States
(12) Patent Application Publication
(10) Pub. No.: US 2002/0015003 A1
(43) Pub. Date: Feb. 7, 2002

(54) Virtual space system structured by plural user terminals and server device

(76) Inventors: Masami Kato, Kanagawa (JP); Ken Sakakibara, Tokyo (JP); Yoshihisa Tadokoro, Tokyo (JP); Takashi Miyasaki, Kanagawa (JP)

Correspondence Address: MORGAN & FINNEGAN, L.L.P., 345 PARK AVENUE, NEW YORK, NY, 10154, US

(21) Appl. No.: 09/923,557

(22) Filed: Aug. 7, 2001

(30) Foreign Application Priority Data
Aug. 7, 2000 (JP) 2000-238379
Nov. 15, 2000 (JP) 2000-348399
Jul. 9, 2001 (JP) 2000-208199

(51) Int. Cl. G09G 5/00

(52) U.S. Cl. 345/1.1

(57) ABSTRACT

A virtual space system is structured by a plurality of user terminals and a server device, and arranged to be able to keep the privacy of each of users when the pictorial image of each user is distributed. In this system, when a user A requests the pictorial image of a user B as the status information of the user B, for example, the interuser distance between the user A and user B is worked out, and corresponding to the interuser distance thus worked out, an image process is given to the pictorial image of the user B. Then, it is controlled to display the pictorial image of the user B on the user terminal device of the user A after the execution of such image process.

### BACKGROUND OF THE INVENTION

1. Field of the Invention

The present invention relates to a dispersion system provided with a plurality of user terminal devices having image-taking (or sensing) means and display means, and a server device connected with each of the user terminal devices through communication lines. The invention also relates to the display control method and storage medium.

2. Related Background Art

Conventionally, each of the organized bodies, such as an enterprise, a group or a public organ, generally secures a working space, namely, an office space, by use of the real estate owned by such organized body itself or by means of a lease contact for the employed workers (hereinafter referred to as workers) who engage in the office work, business activities, or the technical work which does not require any large facilities, among some others. Then, the workers usually utilize public facilities for commuting, their own cars, or the like, to arrive at the designated office space and get together by the time the business hour begins so as to execute each of the assigned duties collectively within designated working hours. In such office space, telephones, copying machines, facsimile equipment, computers, and computer network are provided to implement each work more efficiently.

This behavior of getting workers in one working space is relatively new idea adopted for the efficient management of a factory after the industrial revolution. However, the harmful effect that may be produced by this working behavior, such as the air pollution brought about by the increased numbers of commuters and use of private cars for commuting which cause more traffic congestion, has become more conspicuous in recent years. Along with this, and also, along with the development of communication infrastructure, such as internet, and the advancement of various kinds of communication technology and technique, the organize bodies and workers more seriously take into consideration that the collective working is not necessarily only a working mode made available for them. Thus, in place of this collective working mode, the distributed working arrangement is being given more attention in order to achieve the operational objectives of an organization as a whole in some other way, while enabling each of the workers belonging to the same organization to execute his or her duty at home or in a preferable location.

To implement a distributed working mode for an organization such as an enterprise, it is necessary to provide a structure whereby to enable the workers to communicate with each other by arranging one room in the home of each worker as his or her working space (which is called a home office) which can be connected with the plural home offices dispersed in remote locations through communication lines used for the communication terminal devices in each room, such as a telephone set, a facsimile device, and a communication application system as well. For the communication lines here, the generally subscribed telephone network, the ISDN network, the internet private line, and others are usable, and for the communication application system, the electronic mail system, WWW (World Wide Web) system, and television conference system are made adoptable, among some others.

Here, also, each worker may work in a satellite office, a telecottage, or the like, which is prepared by the organization to which such worker belongs or by a local self-governing body, not necessarily in the home office of his or her own, or may work in a provisional working place (a mobile office) such as in his or her own car or at a seat of a public transportation when he or she visits with a customer when engaged in sales activity or maintenance operation as the case may be.

Now, with reference to FIG. 34 and FIG. 35, the description will be made of the structural example of a distributed working. FIG. 34 is a block diagram which shows the structure of a home office used for the conventional distributed working. FIG. 35 is a table which indicates the typical communication application system used for the conventional distributed working.

As shown in FIG. 34, at the home office 101a for the distributed working, there are arranged the personal computer 102a which is provided with communication application software 103a for communicating with the main office 109a, other home offices 110a or mobile office 111a; a telephone set 105a; a facsimile equipment 106a; and an ISDN terminal adapter (hereinafter referred to as a TA) 104a. The TA 104a is provided with a data port and two analogue ports. The data port is connected to the serial port of the personal computer 102a. One analogue port of the TA 104a is connected with the telephone set 105a, and the other analogue port is connected with the facsimile equipment 106a, respectively.

The TA 104a is connected with the telecommuncation network 108a formed by ISDN net work through a DSU (digital service unit) 107a. The home office 101a communicates with the main office 109a, other home office 110a or mobile offices 111a by utilization of the telecommunication network 108a. Here, in place of the ISDN network, connection may be made with the generally subscribed telephone network using a modem (modulation-demodulation device) to make communication possible with the main office 109a, other home offices 110a or mobile offices 111a.

As the communication application software 103a which is installed on the personal computer 102a, there are, as shown in FIG. 35, electric mail-client software 21a; group schedule management software 22a; the World Wide Web browser software 23a; television conference software 24a; and collaboration software 25a. The electronic mail-client software 21a is the software which is used between workers in the main office 109a, other home offices 110a or mobile offices 111a, and makes it possible to produce electronic mails, execute the transmission and reception, or reading thereof, among some others. The group schedule management software 22a is the one which makes it possible to register and confirm the work schedule of the worker's own, and to confirm the work schedule of others, among some other operation. The World Wide Web browser software 23a is the one used mainly for perusing the home page prepared by the organization to which the worker belongs or perusing the message board put on the home page for use of the members of the organization.

The television conference software 24a is the one that makes it possible to make arrangement or hold conference without going out or traveling to another site actually, and exchange voices and images with other workers through the telecommunication network 108a. The collaboration software 25a is the one which is used for opening the common white board or the same application software on the displays of the respective personal computers between other workers so as to enable them to carry out a collaborated work between them. In some cases, this collaboration software 25a is contained in the television conference software 24a.

Conventionally, when each worker who belongs to an organization works at his or her home office as described above, the business operation is carried out by use of the telephone set 105a, the facsimile equipment 106a, the personal computer 102a, and each of the communication applications installed thereon, while being in contact with other workers.

Also, in recent years, with the development of the network, its use environment is made serviceable so that each worker in the distributed working condition can share information between them through the respective terminals. Then, under the network environment of the kind, such demand as to confirm the status quo of communicating party becomes increasingly more. Here, each user attempts to share the information of status quo of others through the terminal of each user so as to enable operation to be carried out more efficient between them.

Now, as the aforesaid status information, the working status information in an office is taken into consideration. Then, utilizing the network a system has been proposed for managing the working condition, in which the information of working condition at each client terminal is made available for the management by use of a server so that a particular working condition is displayed on the screen of each of the client terminals, hence enabling other workers to confirm such working condition.

For the distributed system of the kind, one example is disclosed in the specification of Japanese Patent Application Laid-Open No. 08-87685, in which a plurality of client terminals and a server are structured on the network, and the server manages each status information formed by the information of each of the users at destination. The status information on the server is updated by the input form the user at each client terminal or depending on the use condition of each client terminal, the personal schedule of each user, and the like, and then, the status information of such user is ready to be distributed to all the connected client terminals.

Also, in the specification of Japanese Patent Application Laid-Open No. 10-254851, there is disclosed the technology that provides a realistic environment for an in-home worker by building a three-dimensional virtual office space so that the indication is given regarding the working condition of other members by the representation of pictorial images accompanied by sound effects.

Now, with reference to FIG. 36 and FIG. 37, the description will be made of the specific example of distributed working that uses the technology of the kind. FIG. 36 is a view which shows the structural example of offices for the conventional distributed working. FIG. 37 is a view which schematically shows the mode of collective working condition before the initiation of the distributed working represented in FIG. 36.

In this respect, as shown in FIG. 36, it is assumed that workers A, B, and C work at each of the home offices 101a, and that a worker D works at the main office and a worker E works in a mobile office. Then, the workers A, B, C, D, and E can communicate with each other by way of the telecommunication network 108a.

Before the initiation of the distributed working of the kind, the working mode is collective as shown in FIG. 37. In this collective working mode, each of the workers A to E works at desk assigned to him or her, respectively. In the case of such collective working, it is possible for the worker A, for instance, to grasp with ease the working condition of each of the workers B to E visually and audibly. Therefore, the worker A can sense the indication that the worker B is not so busy, and he feels that he can talk to the worker B with appropriate timing.

In contrast, when the worker A converse with the worker B in the distributed working condition, for example, this conversation is usually carried out by use of the telephone set 105a or the television conference software 24a (shown in FIG. 34 and FIG. 35). However, when the worker A intends to call the worker B using the telephone set 105a or the television software 24a, he cannot ascertain the working condition of the worker B before issuing such call. Therefore, if the worker B is busy on another line or on a break, and cannot avail himself or herself to respond, the call from the worker A to the worker B is wasted eventually, and a problem such as this makes the work efficiency degraded, among some other problems to be encountered in this respect.

Here, then, the worker A can send out his question to the worker B through the electronic mail system using the electronic mail-client software. With this system, however, it is difficult to make certain how soon the worker B answers even when the question requires an urgent response. Thus, in some cases, the worker A is confronted with difficulty in executing his or her work as planned.

In such a case, the worker A may be able to confirm the schedule of the worker B by means of the group schedule management software 22a. Nevertheless, it is often the case where the registered contents of the group schedule management software 22a are limited to the work plan or work schedule only, and usually, rest time or the like is not registered. Also, the registered contents of the group schedule management software 22a are only those which can be prearranged, not conveying the status quo of each worker actually working. In other words, the group schedule management software 22a cannot be any means for ascertaining the status quo of a party in need for a worker.

In order to solve such problems as discussed above, it is attempted to materialize a method wherein by use of the television conference software 24a, the pictorial images of plural workers are always fetched in and displayed on the screen of each terminal so that each of the workers is in a position to observe the working condition of each of them mutually. To implement this method, there are the Enhanced CU-SeeMe and Reflector (the server software for use of the Enhanced CU-SeeMe) developed and sold by White Pine Software Inc. in U.S.A.

Now, with reference to FIG. 38, this method will be described. FIG. 38 is a view which shows the example displayed on a screen of a personal computer in a home office in accordance with the method in which each of the workers shows his or her working condition for the mutual observations by the workers concerned by use of the television conference software.

With the method that enables each of the workers to show his or her working condition for mutual observations by use of the television conference software, respectively, it becomes possible to confirm, as shown in FIG. 38, whether or not other workers are in the home office or busy on another telephone line, or the like, by the pictorial images of the workers being displayed during office hours continuously, not necessarily limited to the occasions of holding “conference” at times.

However, the method in which each of the workers shows his or her working condition for mutual observations by means of the television conference software, only the names of workers, the pictorial images thereof, and the operational information of the system (the availability of images, the frame rate, the communication speed, and the like) are displayed on the screen, and if the pictorial image of a worker is not present on the video screen, for example, it may indicate that such particular worker is absent on vacation or the like, but it is still impossible to know whether or not there is any possibility that such worker can be reached within a day or to acquire any other related information.

Also, the pictorial images, the names of users, and the like are displayed individually in accordance with the GUI (Graphical User Interface) indication method of a personal computer, and a sense of organizational unity, like a collective work condition, is not obtainable from the representation on this display screen. As a result, each of the workers may be given an impression of being isolated or alienated form others in some cases.

Further, to show the pictorial images of working condition for mutual observations may create a sense of psychological resistance on the part of a worker if he or she feels that the working site and working behavior of the user himself or herself are watched at all times or peeped by other users or the privacy of the user himself or herself is invaded by others.

In the case of the collective working as shown in FIG. 37, the arrangement of the desks (workers) makes it clear that the positional relations between plural workers are such as to enable a worker himself or herself to see others, and viceversa mutually in terms of visibility. Usually, the existence of this feeling of reciprocity allows the worker himself or herself to be released from the general sense that he or she is watched by other workers or the privacy of the worker himself or herself is invaded, despite the fact that the working site and working behavior of the worker himself or herself can be easily watched by the workers surrounding him or her.

However, in the method to allow each of plural workers to present the working conditions themselves for mutual observations by use of the television conference software 24a, it is impossible to maintain such reciprocity as “the one who sees others is the one whom others see”. Conceivably, therefore, the aforesaid sense of psychological resistance is brought about eventually. Here, for example, a privacy protecting function is provided so that when a user should change clothes for executing an assigned work, the pictorial image of such user or the image of user thus image-taken is not transmitted to the terminals of other users. Then, if this privacy protecting function is selected, the status of one-way observation is made available, that is, while the user is relieved from showing the pictorial images of the user working condition to others, this user can still see the working conditions of other users. With this, the reciprocity no longer exists, and there may occur the probability that a user of a computer is being watched by a certain party whose pictorial image is not shown on his or her display screen. This may lead to the danger that the behavior of a worker himself or herself is allowed to be watched in such a manner as described above with the adopting of the method in which each of the workers shows the working condition for mutual observations using the television conference software 24a. Then, this may eventually give the workers such sense of psychological resistance on his part as he or she feels that the working site and working behavior of the worker himself or herself are watched by other workers at all the time.

Also, for the multiple-point television telephone system (Nynex Portholes produced by Nynex Inc., or the like), for which the constant connection is prerequisite, a function is provided for controlling the privacy of the worker himself or herself in such a manner that the filtering process is made available to intentionally degrade the clarity of the pictorial images of working condition as needed, instead of suspending the image transmission completely, hence transmitting the obscure images obtained by the filtering process to the terminals of other users to serve the purpose. Nevertheless, even if this function is executed, there still occurs the asymmetric (unilateral) condition of privacy protection where one user can display the image the amount of information of which is curtailed by means of the filtering process for the pictorial image of the working condition of the user himself or herself as in the case described above, but it is still possible for him or her to see the pictorial images of the working condition of other workers clearly. As a result, the reciprocity between one worker and others no longer functions as anticipated, and there is a danger that other workers embrace the sense of psychological resistance on their part as they feel that their working behavior is watched by such particular worker whose pictorial image is obscure.

Further, it may be possible to arrange the system in which any worker is prohibited from seeing the pictorial images of working condition of others unless the pictorial image of working condition of his or her own is shown, thus maintaining the symmetric (bilateral) condition of privacy protection so as to prevent the reciprocity from being lost. In this case, however, the intended maintenance of reciprocity is unnecessarily exercised even for the party who is not directly concerned with that particular worker who intends to maintain such reciprocity.

### SUMMARY OF THE INVENTION

It is an object of the present invention to provide a distributed system capable of providing an appropriate reciprocity for each of the users, while maintaining the symmetrical (bilateral) condition of privacy protection between each of users, as well as to provide the display controlling method and storage medium therefor.

The distributed system of the present invention is provided with a plurality of user terminal devices having image-taking means and displaying means, and a server device connected with the plurality of user terminal devices through communication lines, and comprises user status recognition means for recognizing the status of user in use of the terminal devices per user terminal device; and control means for controlling the display of user status on the other user terminal device for the displaying means per user terminal device. In this distributed system, when the pictorial image of a user image-taken by image-taking means of the other user terminal device is displayed on one user terminal devices among each of them, the control means works out the interuser distance between such one of user terminal devices and the other user terminal device, and controls the display of the pictorial image of the user on the other user terminal device for the displaying means of such one of user terminal devices in accordance with the interuser distance thus worked out.

Also, the method of the present invention for controlling the display of the distributed system, which is provided with a plurality of user terminal devices having image-taking means and displaying means, and a server device connected with the plurality of user terminal devices through communication lines, comprises comprising the steps of recognizing the status of user in use of the terminal devices per user terminal device; displaying the user status of the other user terminal device on the displaying means per user terminal device; and working out the interuser distance between one of user terminal devices and the other user terminal device when the pictorial image of the user image-taken by image-taking means of the other user terminal device is displayed on displaying means of such one of user terminal devices among each of them, and controlling the display of the pictorial image of user of the other user terminal devices for the displaying means of such one of user terminal devices in accordance with the interuser distance thus worked out.

Also, the sever device of the present invention, which is connected with a plurality of user terminal devices through communication lines, comprises storage medium for storing the information for designating a plurality of virtual spaces to enable a user to reside therein, and the information for designating one specific virtual space among a plurality of virtual spaces to be set by the user; signal receiving means for receiving the user information to be transmitted from one of the plurality of user terminal devices; first signal distributing means for distributing the user information received by the signal receiving means to the other user terminal devices positioned in the specific virtual space set by the use of the user terminal device on the transmitting side of the user information; and second signal distributing means for distributing the user information received by the signal receiving means to the other user terminal devices positioned in the virtual space other than the specific virtual space among a plurality of virtual spaces to enable the user of the user terminal device on the transmitted side of the user information to reside therein.

Also, the user terminal device of the present invention, which is connected with a server device through communication line, comprises first signal transmitting means for transmitting to the server device the information for designating one specific virtual space set by the user among a plurality of virtual spaces for the user to reside therein; acquiring means for acquiring the user information regarding the user; second signal transmitting means for transmitting to the server device the user information acquired by the acquiring means; and reception display means for receiving for display the other user information distributed by the server device.

Also, the virtual space system of the present invention, which is formed by a plurality of user terminal devices, and a server device connected with the plurality of user terminal devices through communication lines for structuring virtual spaces on a network, comprises first signal transmitting means provided for each of the user terminal devices for transmitting to the server device the information for designating the one specific virtual space set by the user among a plurality of virtual spaces for enabling the corresponding user to reside therein; acquiring means provided for each of the user terminal devices for acquiring the user information regarding the corresponding user; second signal transmitting means provided for each of the user terminal devices for transmitting to the server device the user information acquired by corresponding acquiring means among the acquiring means; storage means provided for the server device to store the information for designating a plurality of virtual spaces for the user to reside therein, and the information for designating the specific virtual space transmitted by the first transmitting means; signal receiving means provided for the server device to receive the user information transmitted from the second transmitting means of the plurality of user terminal devices; first signal distributing means provided for the server device to distribute the user information received by the signal receiving means to the other user terminal devices positioned in the specific virtual space set by the user of the user terminal device on the transmitting side of the user information; second signal distributing means provided for the server device to distribute the user information received by the signal receiving means to the other user terminal devices positioned in the virtual space other than the specific virtual space among a plurality of virtual spaces for enabling the user of the user terminal device on the transmitting side of the user information to reside therein; and reception display means provided for each of the user terminal devices to receive and display the other user information distributed by the first signal distributing means or the second signal distributing means.

Also, the method of the present invention for distributing and displaying user information, which is applicable to a virtual space system formed by a plurality of user terminal devices and a server device connected with the plurality of user terminal device through communication lines for structuring virtual spaces within a network, comprises a first signal transmitting step for each terminal device to transmit to the server device the information for designating one specific virtual space set by a user concerned among a plurality of virtual spaces to enable the corresponding user to reside therein; an acquiring step for each user terminal device to acquire user information regarding the corresponding user; a second transmitting step for each user terminal devices to transmit the user information acquired in the acquiring step to the server device; a storing step for the server device to store the information for designating a plurality of virtual spaces to enable a user to reside therein, and the information for designating the specific virtual space transmitted in the first signal transmitting step; a signal receiving step for the server device to receive the user information transmitted from the plurality of user terminal devices in the second transmitting step; a first signal distributing step for the server device to distribute the user information received in the signal receiving step to the other user terminal devices positioned in the specific virtual space set by the user of the user terminal device on the transmitting side of the user information; a second signal distributing step for the server device to distribute the user information received in the signal receiving step to the other user terminal devices positioned in the virtual space other than the specific space among a plurality of virtual spaces for enabling the user of the user terminal device on the transmitting side of the user information to reside therein; and a receiving and displaying step for each user terminal device to receive and display the information of other user distributed in the first signal distributing step or the second signal distributing step.

### BRIEF DESCRIPTION OF THE DRAWINGS

FIG. 1 is a view which shows the structure of a virtual space in accordance with the present embodiment of the present invention.

FIG. 2 is a block diagram which shows the structure of a distributed system in accordance with a first embodiment of the present invention.

FIG. 3 is a view which shows the hardware structure of a host server device 11.

FIG. 4 is a block diagram which shows the hardware structure of the host server device 11.

FIG. 5 is a view which shows the hardware structure of user terminal devices 13 and 15.

FIG. 6 is a view which shows the equipment arrangement in a home office structured by the user terminal device 15.

FIG. 7 is a block diagram which shows the structure of the user terminal software 24 installed on each of the user terminal devices 13, 14, 15, and 16.

FIG. 8 is a block diagram which shows the functional structure of the server S which is installed on the host server device 11.

FIG. 9 is a block diagram which shows the functional structure of a client X in each of the user terminal devices 13, 14, 15, 16, and 17.

FIG. 10 is a block diagram which shows the structures of a status acquiring portion 801 and a user status recognition portion 802.

FIG. 11 is a view which shows one example of an office view screen displayed on the user terminal device in the distributed system.

FIG. 12 is a flowchart which shows the operational procedures of the server S of the host server device 11

FIG. 13 is a flowchart which shows the operational procedures of the client X of each user terminal device.

FIG. 14 is an organization chart for regulating interuser distances in the distributed system.

FIG. 15 is a view which shows the example of a pictorial image of a user who uses one of the user terminal devices.

FIG. 16 is a view which shows the example of a pictorial image processed from the user image represented in FIG. 15 by means of the mosaic treatment of intensity “1”.

FIG. 17 is a view which shows the example of a pictorial image processed from the user image represented in FIG. 15 by means of the mosaic treatment of intensity “2”.

FIG. 18 is a view which shows the example of a pictorial image processed from the user image represented in FIG. 15 by means of graduation treatment.

FIG. 19 is a flowchart which shows the procedures of the main operation of the client X in the distributed system in accordance with a second embodiment of the present invention.

FIG. 20 is a flowchart which shows the procedures of the main operation of the distributed system in accordance with a third embodiment of the present invention.

FIG. 21 is a view which shows the example of a image-taken image of a user using one of the user terminal devices in the distributed system in accordance with a fourth embodiment of the present invention.

FIG. 22 is a view which shows the example of a user pictorial image at the other user terminal device to be displayed on one of the user terminal devices after a gradation treatment is processed in accordance with the clarity of the user image-taken image represented in FIG. 21.

FIG. 23 is a view which shows the example of another image-taken image of a user using one of the user terminal devices in the distributed system in accordance with the fourth embodiment of the present invention.

FIG. 24 is a view which shows the example of a user pictorial image at the other user terminal device to be displayed on one of the user terminal devices after a gradation treatment is processed in accordance with the clarity of the user image-taken image represented in FIG. 23.

FIG. 25 is a view which shows the example of a user pictorial image at the other user terminal device to be displayed on one of the user terminal devices after a mosaic treatment is processed in accordance with the clarity of the user image-taken image represented in FIG. 23.

FIGS. 26A and 26B are views which illustrate the log-in dialogues to be indicated on the display of a user terminal device in accordance with a fifth embodiment of the present invention.

FIG. 27 is a view which shows a virtual space screen called office view to be indicated on the display of a user terminal device in accordance with the fifth embodiment of the present invention.

FIGS. 28A and 28B are views which illustrate each screen of the other user's displayed on the user terminal device existing in the virtual office space.

FIG. 29 is a view which shows the input dialogue for a free message to be indicated on the display of a user terminal device when inputting a free message.

FIG. 30 is a flowchart which shows the operational procedures of a user terminal device.

FIG. 31 is a flowchart which shows the operational procedures of a host server device.

FIG. 32 is a view which shows the input dialogue when a different free message is presented per the virtual space for which log-in is possible.

FIG. 33 is a view which shows the input dialogue when the user information distribution is designated per the virtual space for which log-in is possible.

FIG. 34 is a bloc diagram which shows the structure of a home office for the conventional distributed working.

FIG. 35 is a table which shows the typical communication application system used for the conventional distributed working.

FIG. 36 is a view which shows the structural example of an office of the conventional distributed working.

FIG. 37 is a view which schematically shows the mode of a collective working before the initiation of the distributed working represented in FIG. 36.

FIG. 38 is a view which shows the example of a display screen of a personal computer in a home office by the method in which each of the workers observes the working condition of each of them mutually by use of television conference software.

### DETAILED DESCRIPTION OF THE PREFERRED EMBODIMENTS

Hereinafter with reference to the accompanying drawings, the description will be made of the embodiments in accordance with the present invention.

### First Embodiment

Now, hereunder, with reference to the accompanying drawings, the present embodiment will be described in accordance with the present invention.

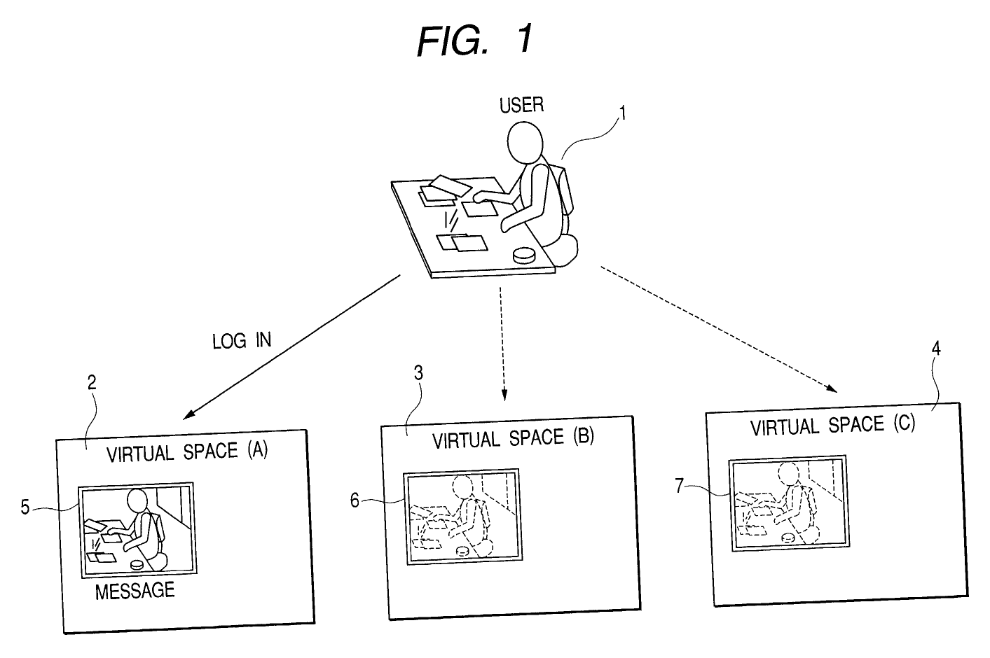

FIG. 1 is a view which shows the outline of a virtual space system embodying the present invention.

The virtual space system of the present embodiment materializes a virtual space system by connecting a plurality of user terminal devices with a host server simultaneously through the telecommunication network.

In FIG. 1, a user 1 logs in a designated virtual space(A) 2 through the network. On the virtual space(A) 2 thus logged in, information (pictorial images and characters) 5 regarding the user 1 is shown, and other users existing in the space concerned are able to see all the information 5 regarding the user 1. At the same time, the information regarding the user 1 is also shown in the other virtual space(B) 3 and virtual space (C) 4 which are set up in advance. However, the contents of the information 6 and information 7, which are shown respectively on the virtual space(B) 3 and virtual space (C) 4, are restricted as compared with the contents of information shown on the virtual space(A) 2 which has been logged in. Therefore, the other users existing in the virtual space(B) 3 and virtual space(C) 4 are aware only of the limited information (presence information and the like) regarding the user 1. The virtual space(A) 2, virtual space(B) 3, and virtual space(C) 4 are set up by the user 1 in advance as a related group.

Next, the detailed description will be made of a distributed office system which is one embodiment of the virtual space system of the present invention.

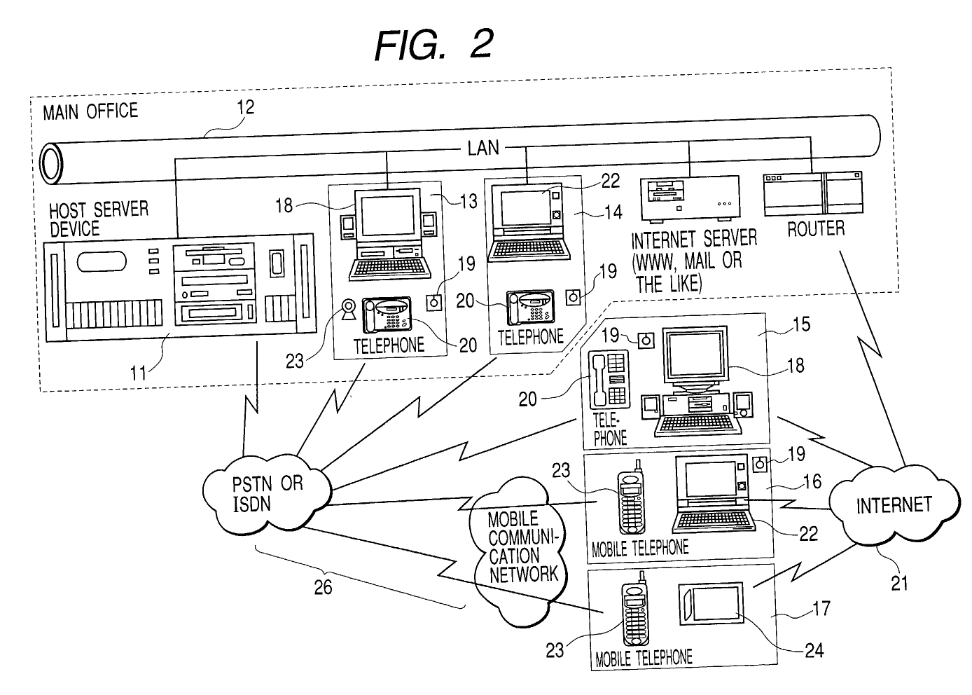

FIG. 2 is a block diagram which shows the structure of the distributed system in accordance with a first embodiment of the present invention.

As shown in FIG. 2, the distributed office system is structured by the main office 10 that serves as the head office or the like; home offices; and mobile offices.

In the main office 10, there are provided a host server device 11; plural user terminal devices 13 and 14; an internet server 24; and a router 25 connected with the internet 21. These are connected with a LAN (Local Area Network) 12.

The host server device 11 is connected with the PSTN (publicly subscribed telephone network) lines 26 which includes the ISDN lines. The host server device 11 is provided with the server process (hereinafter referred to as the server) S which is installed thereon to enable status information to be shared by users. The server S is structured to operate all the time. The server S can be connected with the client process (hereinafter referred to as the client X (0<X<N+1)) arranged for sharing the status information of each of the user terminal devices 13, 14, 15, 16, and 17 to be described later, and hold a status information table having the status information of each user stored thereon. The status information contains the user name; the attendance condition (present or absent); the working condition; the address; the location; the communication party; the party available/unavailable; the input status of input device; the name of operating application; images; and voices, among some others, which indicate the user condition.

The user terminal device 13 is provided with the desk-top personal computer 18 which is connected with the LAN 12; the user terminal software 19 installed on the computer 18; and the telephone set 20 connected with the PSTN line 26. The user terminal device 14 is provided with the note type personal computer 22 which is connected with the LAN 12; the user terminal software 19 installed on the computer 22; and the telephone set 20 connected with the PSTN line 26. The user terminal software 19 for use of each of the user terminal devices 13 and 14 includes the aforesaid client X.

The home office is provided with the user terminal device 15. The user terminal device 15 is provided with the desk-top personal computer 18 which can be connected with the host server device 11 through the internet 21; the user terminal software 19 installed on the computer 18; and the telephone set 20 connected with the PSTN line 26. Also, the user terminal device 16 that constitutes a mobile office is provided with the note type personal computer 22 which can be connected with the host server device 11 through the internet 21; the user terminal software 19 installed on the computer 22; and the mobile telephone 23 connected with the mobile communication network or the PSTN line 26.

The mobile office is provided with the user terminal device 17. The user terminal device 17 is provided with a hand-held type information terminal (WWW browser built-in type) 24 which can be connected with the host server device 11 through the internet 21, and the mobile telephone 23 which is connected with the mobile communication network or the PSTN line 26.

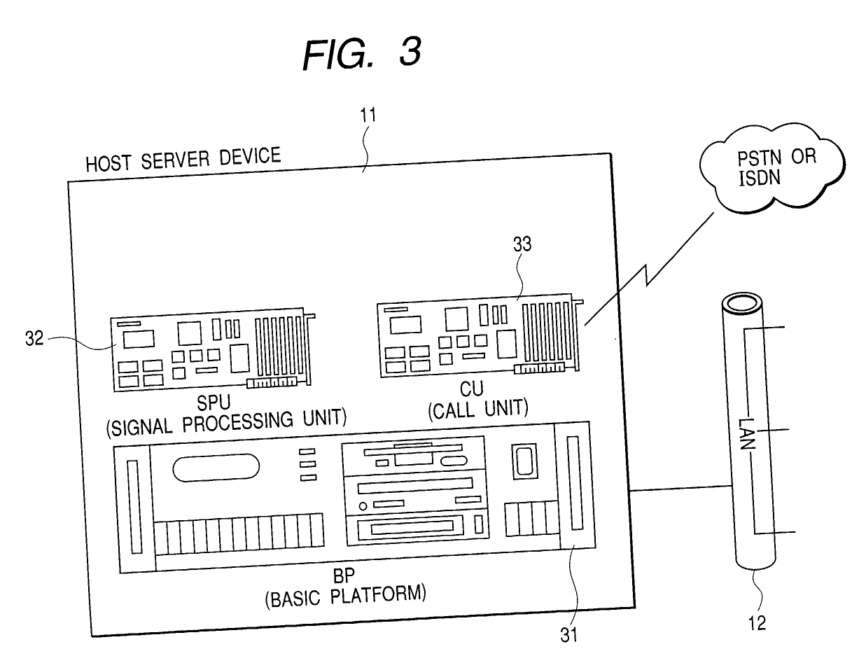

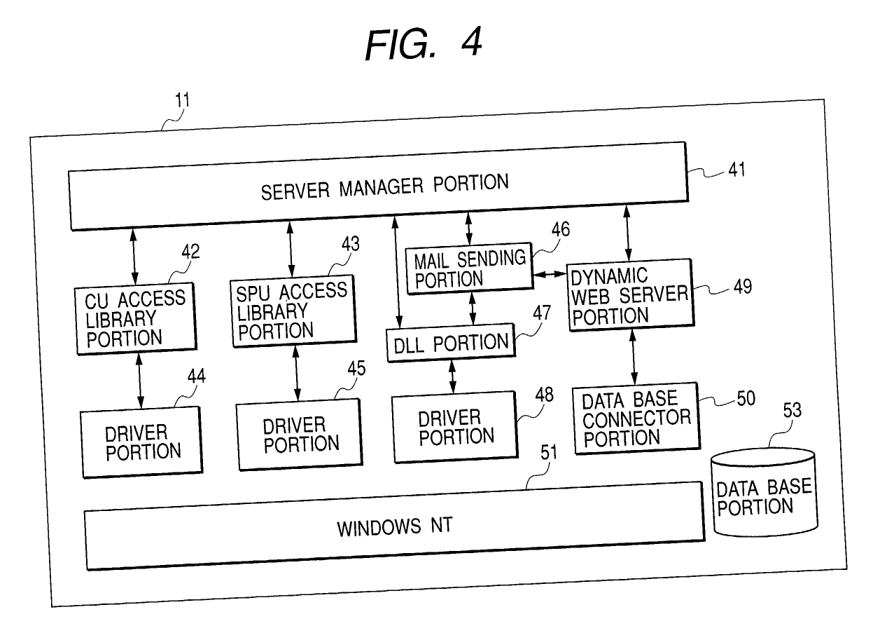

Next, with reference to FIG. 3 and FIG. 4, the description will be made of the host server device 11. FIG. 3 shows the hardware structure of the host server device 11 represented in FIG. 2. FIG. 4 is a block diagram which shows the software structure of the host server device 11 represented in FIG. 2.

As shown in FIG. 3, the host server device 11 comprises the BP (Basic Platform) 31 which is a PC server device; the SPU (Signal Processing Unit) 32 which serves as a parallel DSP (Digital Signal Processor); and the CU (Call Unit) 33 which serves as a telephone line board (Computer Telephony Board). The BP 31 is connected with the LAN board (not shown) through the LAN 12, and CU 33 is connected with the PSTN lines 26.

The software which is installed on the host server device 11 contains a software program developed by use of C++ language or the like, as well as known software programs, and adopts the Windows NT (Registered trade mark of Microsoft Inc., in U.S.A.) as the OS (Operating System) therefor.

More specifically, as shown in FIG. 4, each kind of software operates on the Windows NT51, and with each kind of software, there are formed the following functional blocks, respectively: the server manager portion 41; the CU access library portion 42; the SPU access library portion 43; the driver portion 44 of the CU access library portion 42; the driver portion 45 of the SPU access library portion 43; the mail sending portion 46; the DLL (Dynamic Link Library) portion 47; the driver portion 48 thereof; the dynamic Web server portion 49; the data base connecting portion 50; and the data base portion 53.

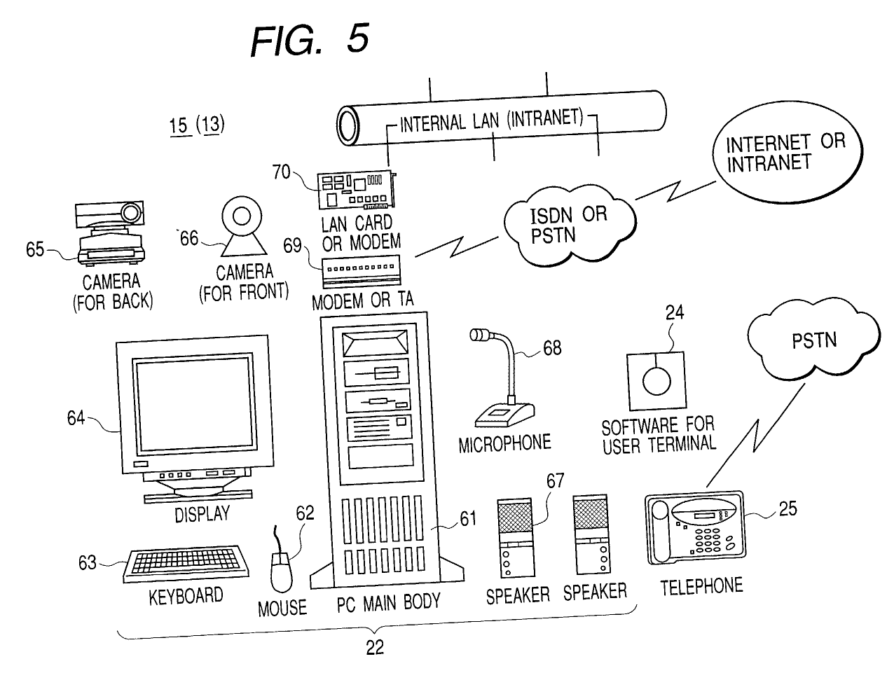

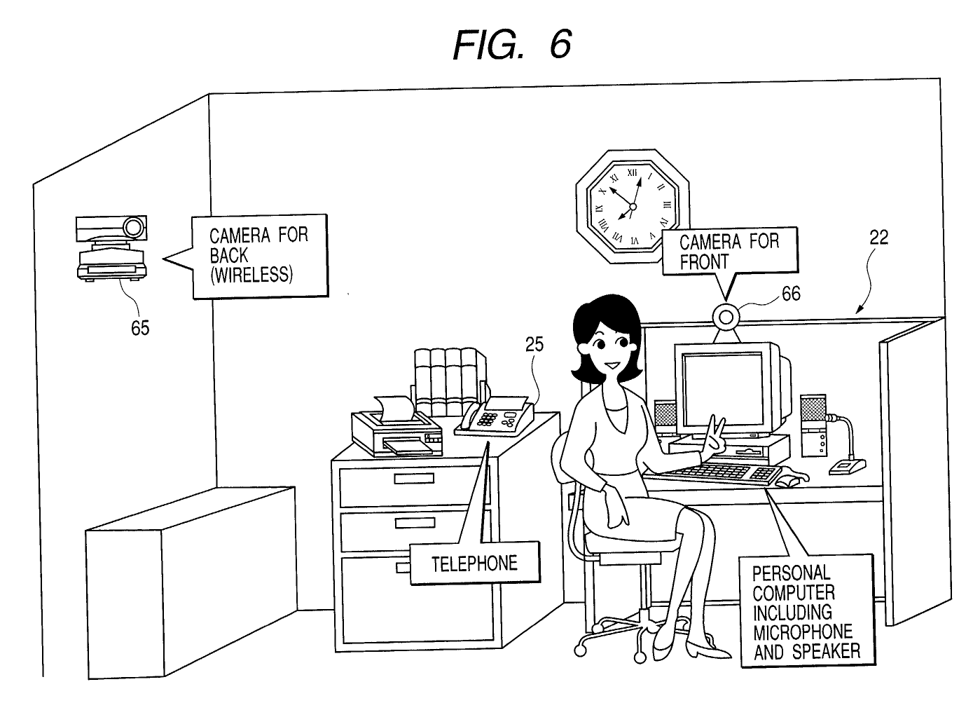

Next, with reference to FIG. 5, the description will be made of the structure of user terminal devices 13 and 15. FIG. 5 shows the hardware structure of the user terminal devices 13 and 15 represented in FIG. 2. FIG. 6 shows the equipment arrangement in the home office structured by the user terminal device 15 represented in FIG. 2. Here, the structures of the user terminal device 13 and the user terminal device 15 are fundamentally the same. Therefore, the structure of the user terminal device 15 will be described.

As shown in FIG. 5, the user terminal device 15 is provided with a personal computer 22; software 24 for use of the user terminal; and a telephone set 25. The personal computer 22 is provided with the PC main body 61, and the corresponding peripheral devices are connected to the respective input and output terminals provided for the PC main body 61. For the present embodiment, there are connected a mouse 62; a key board 63; a display 64; speakers 67; a microphone 68; a modem 69; a camera 66 for the front use for image-taking the user; and a camera 65 for the rear use, respectively. Also, for the user terminal device 13, the LAN card 70 is installed on the PC main body 61 for connecting the LAN 12. The user terminal device 15 is installed in the home office. Therefore, the installation of the LAN card 70 is not needed for the user terminal device 15.

Here, in a home office, each of the equipment and devices of the user terminal device 15 is arranged as shown in FIG. 6, for example. The personal computer 22 is put on the desk, and the camera 66 for the front use is arranged in a position to be able to capture from front the user who operates the personal computer 22. Also, the cameral 65 for the rear use is arranged in a position to be able to capture from behind the user who operates the personal computer 22. In this respect, the arrangement of each equipment and device of the user terminal device 13 in the main office 11 is the same as that of those shown in FIG. 6.

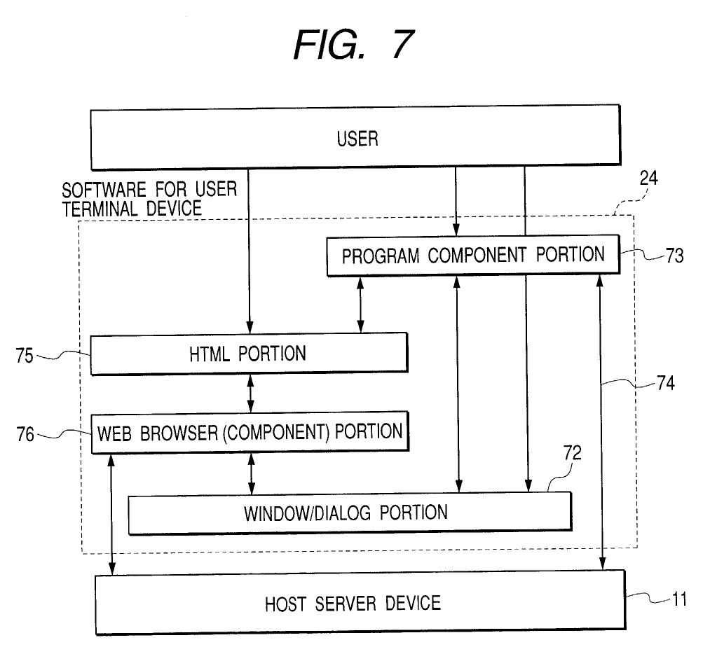

Now, with reference to FIG. 7, the description will be made of software 24 (19) for use of the user terminal installed on each of the user terminal devices 13, 14, 15, and 16. FIG. 7 is a block diagram which shows the user terminal software 24 installed on each of the user terminal devices 13, 14, 15, and 16 shown in FIG. 2.

The user terminal software 24 contains the software program developed by use of C++ language, as well as the known software programs. Here, the Windows 95 (Trade Mark of Microsoft Inc., U.S.A) is adopted as the OS therefor. More specifically, with each software operating on the Windows 95, there are structured the respective functions of the Window/Dialog portion 72, the program component portion 73, the HTML portion 75, the Web Browser (component) portion 76 as shown in FIG. 7. The program component portion 73 and the Web Browser (component) portion 76 are connected with the host server device 11 through signal lines 74.

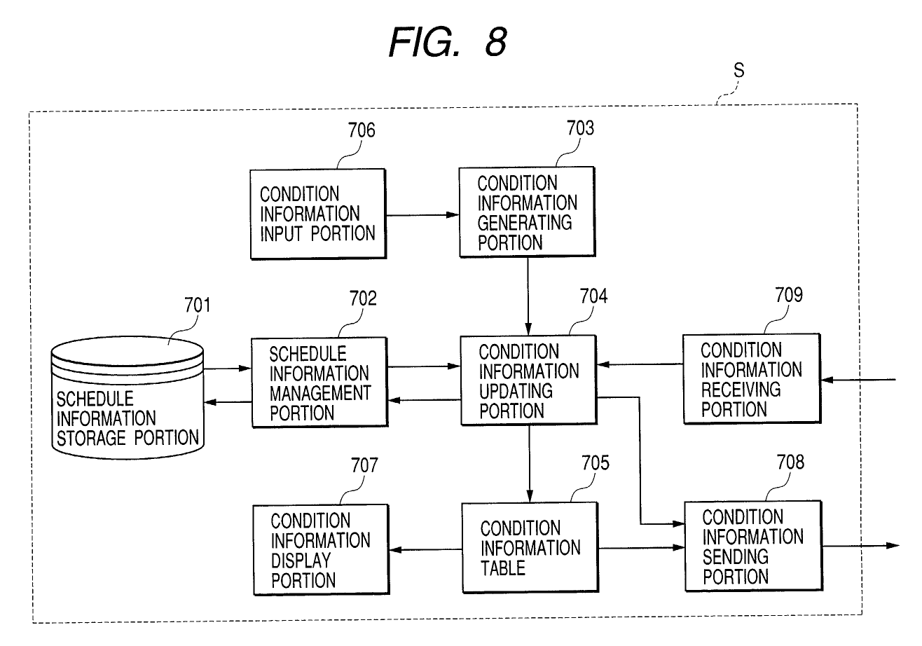

Next, with reference to FIG. 8, the description will be made of the server S installed on the host server device 11. FIG. 8 is a block diagram which shows the functional structure of the server S installed on the host server device 11 represented in FIG. 2.

The server S manages the user status information of each of the user terminal devices 13, 14, 15, 16, and 17 connected by way of the network, such as the LAN 12, the PSTN lines 26 or the internet 21, and then, transmits the updated information to each of the user terminal devices 13, 14, 15, 16, and 17. As shown in FIG. 8, the server S comprises a schedule information storage portion 701; a schedule information management portion 702; a status information generating portion 703; a status information updating portion 704; a status information table 705; a status information input portion 706; a status information display portion 707; a status information sending portion 708; and a status information receiving portion 709.

The schedule information storage portion 701 stores the schedule information of each user. Then, the schedule information management portion 702 manages the schedule information of each user. The schedule information management portion 702 writes the schedule information of each user in, reads it out from, or deletes it from the schedule information storage portion 701 in accordance with the request form the user (from the status information updating portion 704). Also, the schedule information management portion 702 processes the schedule information read out from the schedule information storage portion 701 to be converted to the status information.

The status information input portion 706 inputs command for operating the status information of each of the user terminal devices 13 and 14, and the command for operating the server S as well. The status information and schedule information thus inputted are provided for the status information generating portion 703. The status information generating portion 703 generates the status information signal formed by the command for operating the status information of each of the user terminal devices 13 and 14, and also, by the command for operating the server S. The status information signals thus generated are inputted into the status information updating portion 704.

The status information receiving portion 709 receives the status information signal that indicates the user condition transmitted from each of the user terminal devices 15, 16, and 17. The status information signal contains the command for operating the status information of each of the user terminal devices 15, 16, and 17 and the schedule information, as well as the command for operating the server S, among some others. The status information signals thus received are inputted into the status information updating portion 704.

The status information updating portion 704 performs processes in accordance with the user statue information signals inputted from the status information generating portion 703 or the status information receiving portion 709. For example, if the status information signal thus inputted contain the status updating command as the one for operating the status information, the related information contained on the status information table 705 is updated accordingly in accordance with the status information contained in the inputted status information signal. Also, if the status information acquiring command is contained in the inputted status information signal as the command for operating the status information, the updated information on the status information table 705 is instructed to be transmitted to the designated user terminal device in accordance with the inputted status information acquiring command. Here, if the requested status information is the user pictorial image of the user B, for example, the display control of the user pictorial image of the user B is executed corresponding to the interuser distance (logical distance) between the user A who has requested the user pictorial image, and the user B whose user pictorial image has been requested. The details of the display control will be described later.

The status information table 705 contains the name of each user; attendance (presence) information; working condition; address; location; contact party; availability/unavailability; the input status of input device; the name of operating application; pictorial images; sounds; and other personal information related to the user status information. The status information recorded on this table is read out by the instruction from the status information updating portion 704 and transmitted to the status information display portion 707 or to the status information sending portion 708, and also, updated appropriately. Here, when the status information is transmitted to the status information sending portion 708, the transmission command that contains the parties to which this status information should be distributed is dispatched from the status information updating portion 704 to the status information sending portion 708.

The status information display portion 707 displays the status information received from the status information table 705. The status information sending portion 708 transmits the status information to the designated receiving parties in accordance with the transmission command from the status information updating portion 704.

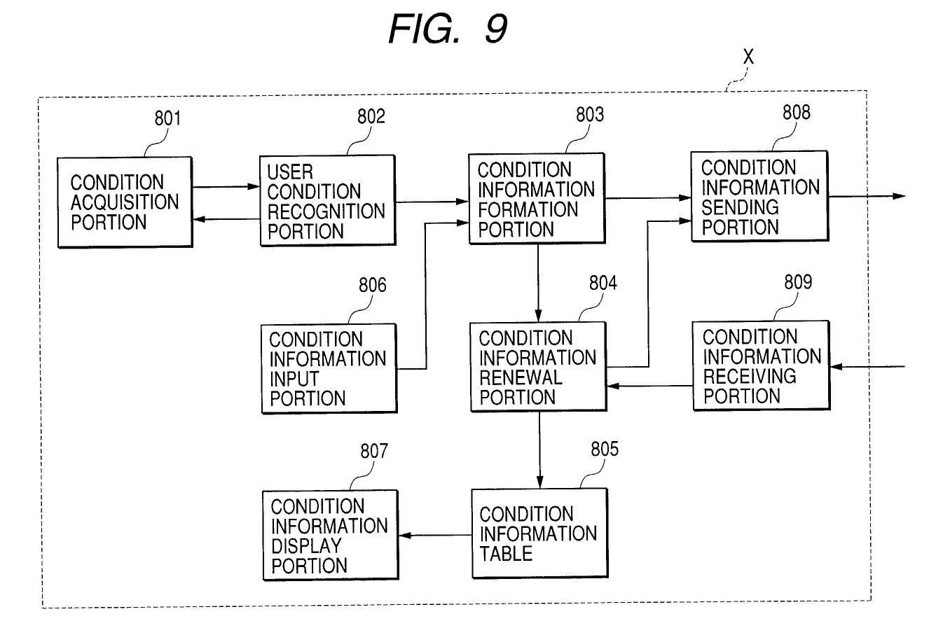

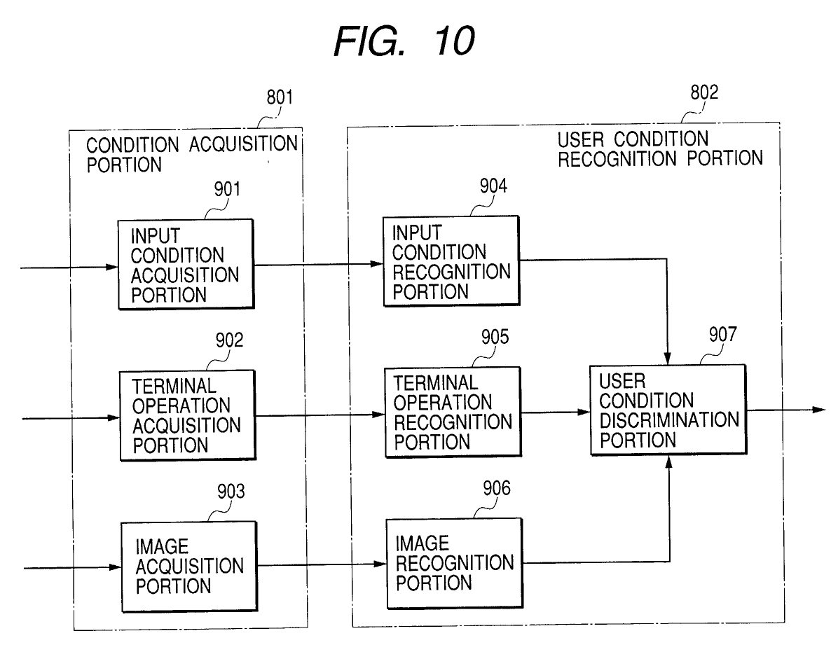

Next, with reference to FIG. 9 and FIG. 10, the description will be made of the structure of client X of each of the user terminal devices 13, 14, 15, 16, and 17. FIG. 9 is a block diagram which shows the functional structure of the client X of each of the user terminal devices 13, 14, 15, 16, and 17 represented in FIG. 2. FIG. 10 is a block diagram which shows the structures of the status acquiring portion 801 and the user status recognition portion 802 represented in FIG. 9.

The client X is provided with the interface for displaying the status information to display the updated status information of the user who operates the client X, and other users as well, while updating the status information in accordance with the updating command regarding the status information of the user concerned. Also, in cooperation with the server S, the client X keeps the status information between users.

As shown in FIG. 9, the client X comprises a status acquiring portion 801; a user status recognition portion 802; a status information generating portion 803; a status information updating portion 804; a status information table 805; a status information input portion 806; a status information display portion 807; a status information sending portion 808; and a status information receiving portion 809.

The status acquiring portion 801 is a functional portion to acquire the status of the user who operates the client X concerned. More specifically, as shown in FIG. 10, the status acquiring portion 801 comprises an input status acquiring portion 901 for obtaining the input status of the input device, such as the key board of the user concerned; a terminal operation acquiring portion 902 for examining the application currently in use in order to obtain the operating condition of the user terminal device of the user concerned; and an image acquiring portion 903 for obtaining the image data (still image or moving image) of the user image-taken by a camera. With these portions, the status acquiring portion 801 obtains each kind of user conditions, such as input status, terminal operating condition, and pictorial images, among some others. Each kind of user conditions thus acquired is inputted into the user status recognition portion 802.

The user status recognition portion 802 is a functional portion to actuate the status acquiring portion 801 periodically or by the command from the status information generating portion 803 in order to obtain the status of user concerned, while recognizing the attending status of the user concerned form each kind of user conditions inputted from the status acquiring potion 801.

More specifically, as shown in FIG. 10, the user status recognition portion 802 comprises an input status recognition portion 904; a terminal operation recognizing portion 905; an image recognizing portion 906; and a user status discriminating portion 907. The input status recognition portion 904 recognizes the working condition of the user concerned, such as presence or absence, extremely busy or not, among some others, which are obtained by the input status acquiring portion 901. The terminal operation recognizing portion 905 recognizes the current status of the user concerned, such as his or her working condition or being extremely busy or not, among some others in accordance with the application being in operation for the user concerned and the terminal operating condition acquired by the terminal operation acquiring portion 902. The image recognizing portion 906 recognizes whether or not the user concerned is present around the user terminal device or the current status, such as his or her working condition or being extremely busy or not in accordance with the pictorial images of the user (still image or moving image) obtained by the image acquiring portion 903.

Each of the recognized results of the input status recognition portion 904, the terminal operation recognizing portion 905, and the image recognizing portion 906 is inputted into the user status discriminating portion 907. The user status discriminating portion 907 recognizes the current status of the user concerned by discriminating the attending condition of the user concerned, his or her working condition, or being extremely busy or not, among some others in accordance with each of the recognized results thus inputted. The user status thus recognized is inputted into the status information generating portion 803.

The status information input portion 806 inputs the command to operate the status information of the user terminal device concerned, and the contents of the schedule information storage portion 701, as well as and the command to operate the server S. These pieces of information thus inputted are provided for the status information generating portion 803. The status information generating portion 803 generates the status information signal formed by the command for operating the status information and schedule information of the user concerned, and also, by the command for operating the server S in accordance with the information inputted from the status information input portion 806, and also, with the user working condition inputted from the user status recognition portion 802. The status information signal thus generated is inputted into the status information updating portion 804.

The status information receiving portion 808 receives the status information signal transmitted from the server S for the indication of the user condition. Here, the status information signal contains the status information of each of the user terminal devices 13, 14, 15, 16, and 17, and the command for updating the status information table 805, among some others. The status information signal thus received is inputted into the status information updating portion 804.

The status updating portion 804 executes an assigned processing in accordance with the input of user status information signal from the status information generating portion 803 or from the status information receiving portion 808. For example, if the status information updating command is contained in the input of the status information signal as a status information operating command, the stored information on the status information table 805 is updated in accordance with the status information contained in the status information signal thus inputted. Also, if the status information requesting command is contained in the input of status information signals as a status information operating command, the status information thus generated by the status information generating portion 803 is instructed to be transmitted to the server S in accordance with such input of the status information requesting command.

Also, the status information table 805 is the one that records the personal information related to the user status information, such as the name of each user; attendance (presence) information; working condition; address; location; contact party; availability/unavailability; the input status of input device; the name of operating application; pictorial images; and sounds, among some others. Each status information on the status information table 805 is read out as instructed by the status information updating portion 804 and transmitted to the status information display potion 807. Also, in synchronism with the status information table 705 on the server S, the contents thereof are updated appropriately so that the contents on both of them are always in agreement.

The status information display portion 807 displays the status information read out from the status information table 805. The status information sending portion 808 transmits the status information signals generated by the status information generating portion 803 to the server S in accordance with the transmission command from the status information updating portion 704.

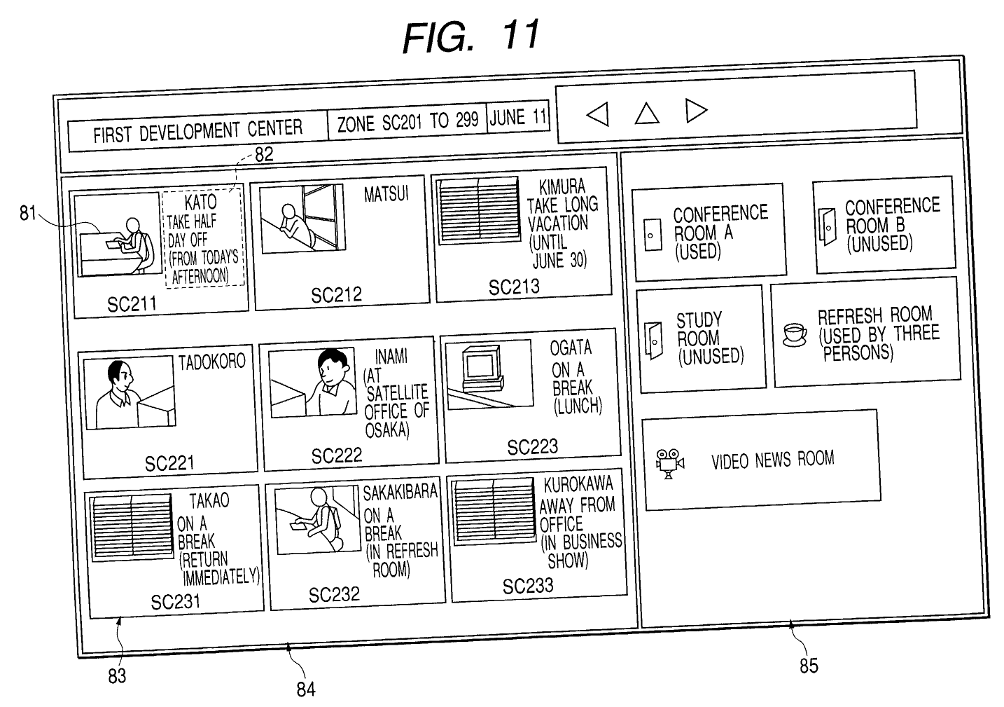

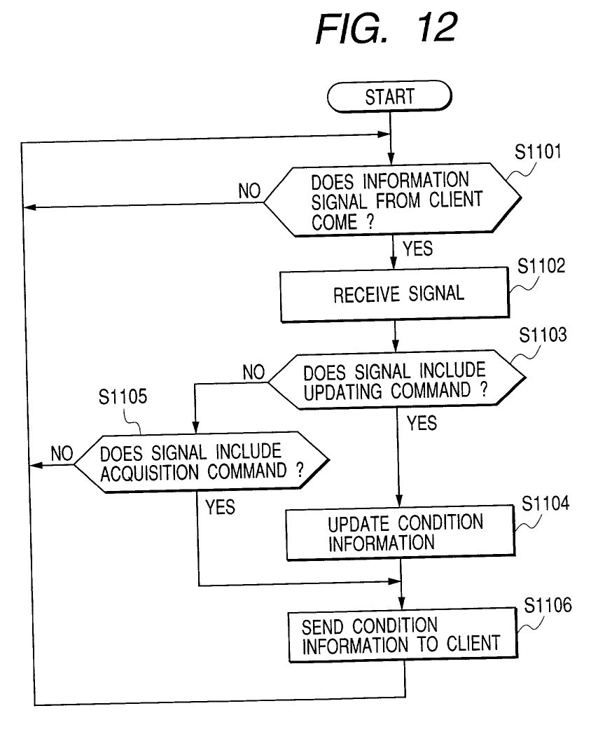

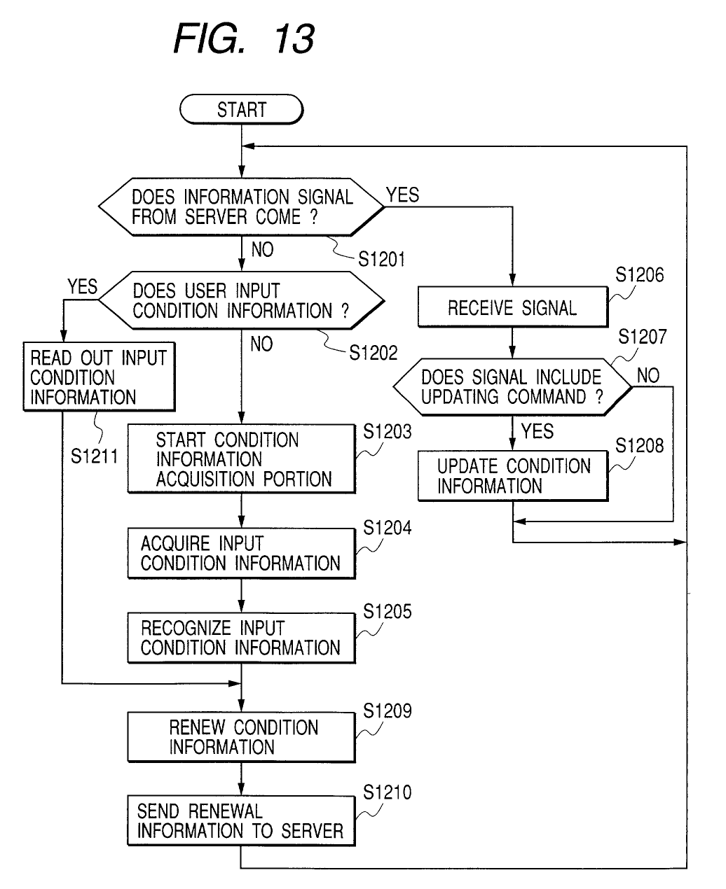

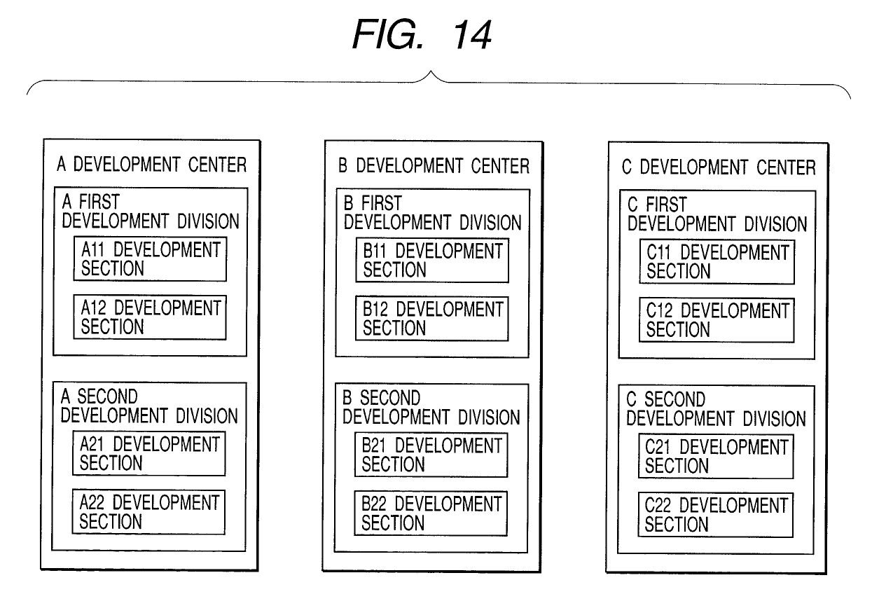

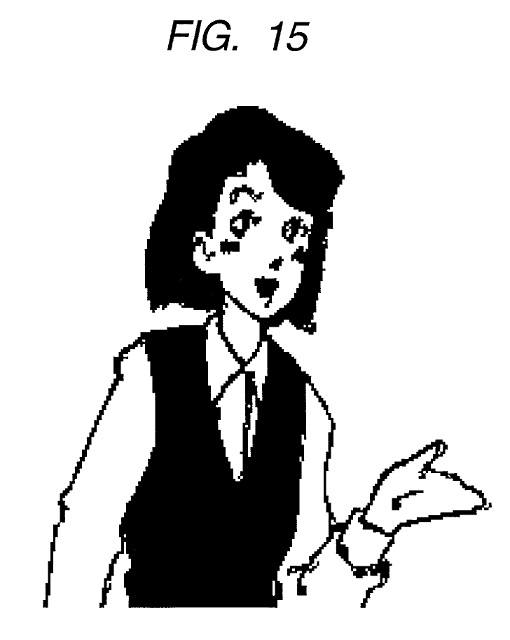

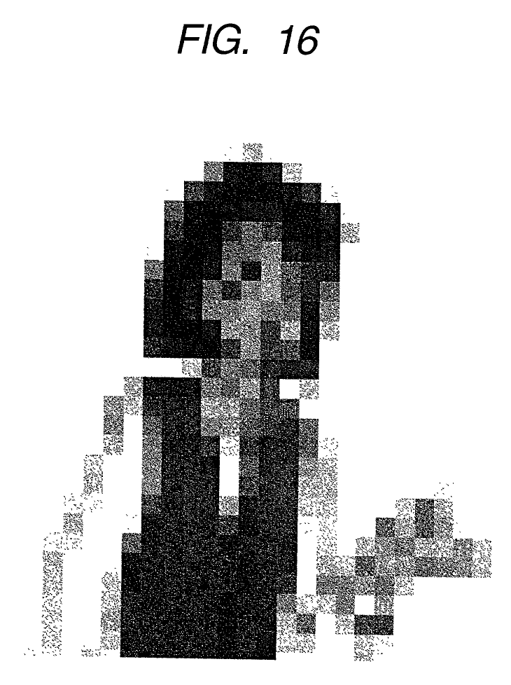

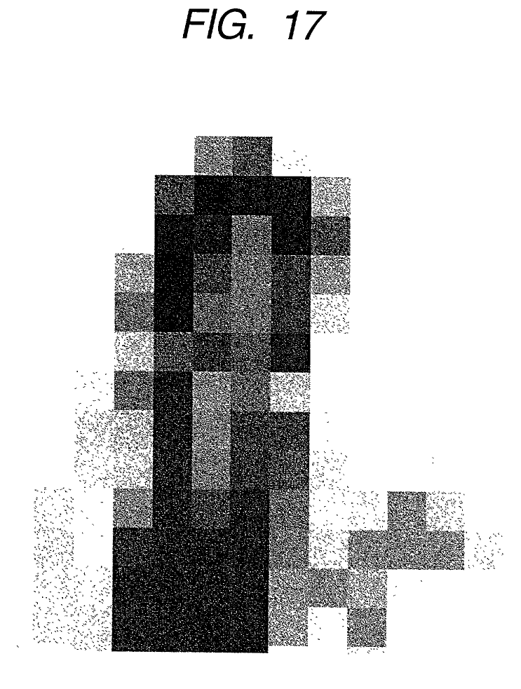

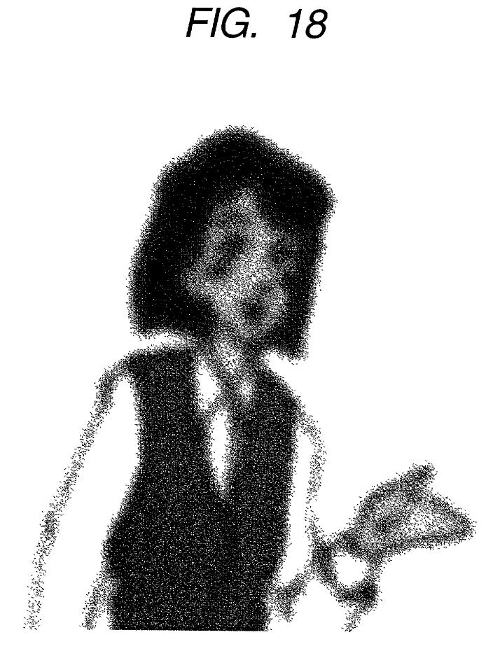

Next, with reference to FIG. 11 to FIG. 18, the description will be described of the operation of the distributed system in accordance with the present embodiment. FIG. 11 is a view which shows one example of an office view screen displayed on the user terminal device in the distributed system represented in FIG. 2. FIG. 12 is a flowchart which shows the operational procedures of the server S of the host server device 11 represented in FIG. 2. FIG. 13 is a flowchart which shows the operational procedures of the client X of each user terminal device represented in FIG. 2. FIG. 14 is an organization chart for regulating interuser distances in the distributed system represented in FIG. 2. FIG. 15 is a view which shows the example of a pictorial image of a user who uses one of the user terminal devices represented in FIG. 2. FIG. 16 is a view which shows the example of a pictorial image processed from the user image represented in FIG. 15 by means of the mosaic treatment of intensity “1”. FIG. 17 is a view which shows the example of a pictorial image processed from the user image represented in FIG. 15 by means of the mosaic treatment of intensity “2”. FIG. 18 is a view which shows the example of a pictorial image processed from the user image represented in FIG. 15 by means of graduation treatment.

When each user is on duty, the office view display that represents the working conditions of other users is indicated on the screen of the user terminal device as shown in FIG. 11, for example. In this example, nine private office 83 are shown on the private room area 84, while the conference rooms and the use conditions thereof are shown on a common area 85. Here, it is possible to display the user pictorial image 81 image-taken by cameras 65 and 66 and the data 82 on the user working condition that indicates the status quo of the user on duty in each of the private offices 83. Also, it is possible to show an icon that indicates that the user is out of office, on break, or the like so that he is not present, besides the pictorial image of the user taken by the cameras 65 and 66. In this respect, the office view screen display is not necessarily limited to the one shown in FIG. 11. It is of course possible to set arbitrarily the number of private offices to be shown, and the display layout thereof.

Now, with reference to FIG. 12 and FIG. 13, the description will be made of the process in which status information is shared by the server S and the client X.

As shown in FIG. 12, the server S waits, at first in step S1101, for the arrival of the status information signal from the client X. When the status information signal arrives, the process proceeds to step S1102 where the status information receiving portion 709 receives the status information signal. Then, the process proceeds to step S1103 where the status information updating portion 704 determines whether or not the received status information signal contains any updating command. If no updating command is contained, the process proceeds to step S1105 where the status information updating portion 704 determines whether or not the received status information signal contains any status acquiring command. If no status acquiring command is contained, the process returns to the step S1101.

In the step S1103, if the updating command is founded to be contained, the process proceeds to step S1104 where the status information updating portion 704 updates the information on the status information table 705 in accordance with the status information contained in the status information signal thus received. Then, continuously, in step S1106, the status information updating portion 704 reads out the updated status information from the status information table 705 to transmit it to each of the user terminal devices through the status information sending portion 708.

In the step S1105, if the status information acquiring command is found to be contained, the process proceeds to step S1106 where the status information updating portion 704 reads out the corresponding updated status information from the status information table 705 in accordance with the status information acquiring command, and transmit it to the designated user terminal device through the status information sending portion 708. Here, if the requested status information is the pictorial image of the user B, for instance, and the requesting part of this pictorial image of the user B is the user A, the display control of the pictorial image of the user B is executed in accordance with the distance between the user A and the user B.

Now, with reference to FIG. 14 to FIG. 18, the description will be made of the display control of a user pictorial image executed by the status information updating portion 704 corresponding to the interuser distance.

For example, if the pictorial image of the user B is requested to the server S from the user A as the status information of the user B, the status information updating portion 704 works out the distance between the user A and user B, and then, the pictorial image of the user B is given image treatment corresponding to the interuser distance thus worked out in order to control the pictorial image of the user B for the display thereof on the user terminal device of the user A after such image treatment. The image treatment is a filtering process, such as a mosaic treatment, graduation. The intensity of the filtering process thereof is set so that it becomes more intensified as the interuser distance become greater. Also, in accordance with the present embodiment, the organizational distance between the user A and user B is adopted as the interuser distance. Here, the organization distance is meant to indicate a distance between each of the divisions in one organization, and a system controller or the like determines it depending on the operational contents of each division and the relationship between each of the division, among some other factors.

For example, FIG. 14 shows the structure of an organization. When the user A who belongs to the All development section requests the server S for the pictorial image of the user B who belongs to the same development section as the user A s the status information of the user B, the status information updating portion 704 works out the organizational distance (organizational relations) between the user A and user B as the interuser distance of the users A and B. Here, since the user A and user B belong to the same development section, the organization distance between the user A and user B is worked out as “0”, and corresponding to the interuser distance “0” thus worked out, the intensity of the filtering process is set at “0” for the pictorial image of the user B. In other words, no filtering process is executed for the pictorial image of the user B. Then, the pictorial image of the user B is transmitted to the user A without giving any filtering process. Now, for example, if a pictorial image shown in FIG. 15 is received as the pictorial image of the user B, the one shown in FIG. 15 is transmitted to the user A without giving any filtering process eventually. Here, the intensity “0” indicates that no execution of any filtering process. Then, it is assumed that the greater the number of this intensity, the greater becomes the degree of filtering process.

When the user B belongs to the A12 development section of the same development division to which the user A belongs, the user A and user B belong to the same development division. In this case, the organizational distance between the user A and user B is worked out as “1”. Then, corresponding to the interuser distance “1” thus worked out, the intensity of the filtering process of the pictorial image of the user B is set at “1”. In other words, for the pictorial image of the user B, the filtering process of intensity “1” is executed, and the pictorial image of the user B is transmitted to the user A after having executed the filtering process the intensity of which is “1”. For example, if a pictorial image shown in FIG. 15 is obtained as the pictorial image of the user B, the filtering process (here, a mosaic treatment) of intensity “1” is given to the pictorial image shown in FIG. 15, thus obtaining a pictorial image shown in FIG. 16, which is transmitted to the user A as the pictorial image of the user B after the execution of the filtering process.

When the user B belongs to the A21 development section of the same development center as the user A, the organizational distance between the user A and user B is worked out as “2”, because the user A and user B belong to the same development center. Therefore, the intensity of the filtering process is set at “2” for the pictorial image of the user B corresponding to the interuser distance of “2” thus worked out. In other words, the pictorial image of the user B is given the filtering process the intensity of which is “2”. Then, the pictorial image of the user B is transmitted to the user A after having executed the filtering process of intensity “2”. For example, if a pictorial image shown in FIG. 15 is obtained as the pictorial image of the user B, the pictorial image shown in FIG. 15 is given the filtering process of intensity “2” (here, a mosaic treatment), thus obtaining the pictorial image shown in FIG. 17, which is transmitted to the user A as the pictorial image of the user B after having executed the filtering process.

When the user B belongs to the B11 development section of the development center which is different from the one to which the user A belongs, the user A and user B belong to the development centers which differ from each other. Therefore, the organizational distance between the user A and user B is worked out as “3”. Then, the intensity of the filtering process is set at “3” for the pictorial image of the user B corresponding to the interuser distance of “3” thus worked out. In other words, the pictorial image of the user B is given the filtering process of intensity “3”. Then, the pictorial image of the user B is transmitted to the user A after having executed the filtering process of intensity “3”.

Also, on the contrary, if the pictorial image of the user A is requested from the user B as the status information of the user A, the organizational distance between the user A and user B is worked out in the same manner as in the case of the user A requesting the pictorial image of the user B, and corresponding to this organizational distance, the filtering process is given to the pictorial image of the user A. Thus, after this filtering process, the pictorial image of the user A is transmitted to the user B.

As described above, if the user A requests the server S for the pictorial image of the user B as the status information of the user B, the organizational distance between the user A and user B (namely, the interuser distance) is worked out, and the image process is given to the pictorial image of the user B in accordance with the organizational distance thus worked out. Then, the pictorial image of the user B is controlled to be displayed on the user terminal device of the user A after the execution of the image process. As a result, the symmetrical (bilateral) privacy protection is maintained between the users A and B to make it possible to provide an appropriate reciprocity for each of the users A and B.

In this respect, for the present embodiment, the organizational distance is worked out depending on the place of duty to which each user belongs. However, when the pictorial image of the user B is requested by the user A, the user B may be requested to change the organizational distance between the users A and B. Then, if the user B accepts this request, the organization distance can be changed to be the one as requested by the user A. For example, in order to know the detailed status of the user B, the organizational distance of which is “3” from the user A, it is necessary for the user A to request for the change of this organizational distance “3” into the one having a smaller value. When this request is accepted by the user B, the organization distance is made smaller, thus making it possible to lower the barrier of the bilateral (symmetric) private protection between the users A and B.

Also, for the present embodiment, the mosaic treatment is exemplified as the aforesaid filtering process. However, the structure may be arranged so as to apply gradation treatment in place of the mosaic treatment. In this case, with the gradation treatment of intensity corresponding to the organizational distance being proved for the pictorial image of the user B shown in FIG. 15, for example, the pictorial image shown in FIG. 18 can be obtained. Then, the pictorial image is transmitted to the user A as the pictorial image of the user B after the execution of the filtering process.

Next, with reference to FIG. 13, the description will be made of the operation of the client X.

As shown in FIG. 13, the client X determines whether or not the status information signal has been received from the server S at first in step S1201. If the status information signal is received from the server S, the process proceeds to step S1206. If the reception of the status information signal is not recognized, the process proceeds to step S1202.

In the step S1206, the status information receiving portion 809 received the status information signal from the server S. Then, the following step S1207, the status information updating portion 804 determines whether or not the status information signal received from the server S contains any status information updating command as the status information operating command. If any status information updating command is not found to be contained, the process proceeds to step S1202. When the status information updating portion is found to be contained, the process proceeds to S1808 where the status information updating portion 804 updates the related information on the status information table 805 in accordance with the status information signal thus received. Then, the process returns to the step S1201.

In the step S1202, it is determined whether or not there is any input of status information from the user in the status information input portion 806. Then, if the user is found to have inputted the status information in the status information input portion 806, the process proceeds to step S1211 where the status information generating portion 803 reads in the status information of the user and generates the status information operating command, as well as the status information signal that contains the status information from the user. In continuation, the process proceeds to step S1209 where the status information updating portion 804 updates the related information on the status information table 805 in accordance with the status information signal thus generated. Thus, the process proceeds to step S1210 where the status information updating portion 804 reads out the updated status information from the status information table 805, and transmits it to the server S through the status information sending portion 808, hence returning to the step S1201.

In the step S1202, if it is determined that there is no user input of any status information in the status information input portion 806, the process proceeds to step S1203 where the status information generating portion 803 actuates the status information acquiring portion 801 in order to update the user status information periodically. Then, in the following step S1204, the status information acquiring portion 801 obtains from the input status acquiring portion 901 the user input status to the input device, such as the key board, and obtains from the terminal operation acquiring portion 902 the name of application that the user currently uses, as well as the terminal operating status, and also, obtains from the image acquiring portion 903 the pictorial image of the user (still image or moving one). Here, each status thus acquired is inputted into the user status recognition portion 802. Thus, the process proceeds to step S1205 where the user status recognition portion 802 recognizes the status of user attendance (presence) or the like in accordance with the input of various kinds of status information. For example, the user status recognition portion 802 recognizes the status of user attendance (presence), the working condition (if he or she is extremely busy or not), or the like in accordance with the input of status information when it is inputted from the input status acquiring portion 901 into the user input device, such as a key board. Also, when there are the input of the name of application that the user currently uses, and that of the terminal operating status, which are acquired by the terminal operation acquiring portion 902, the working condition of the user concerned, the pressure under which he or she works at present are recognized among some others. Further, when there is the input of the user pictorial image which is obtained by the image acquiring portion 903 (still image or moving one), it is recognized whether or not he or she is present around the user terminal device together with his or her current working condition, as well as the pressure under which he and she works at present in accordance with the pictorial image of the user concerned. The user status information thus recognized is transmitted to the status information generating portion 803. Then, the status information generating portion 803 generates the status information signal that contains the user status information, and the status information updating command.

After that, the process proceeds to step S1209 where the status information updating portion 804 updates the related information on the status information table 805 in accordance with the status information signal thus generated. Then, the process proceeds to step S1210 where the status information updating portion 804 reads out the updated information from the status information table 805 and transmit it to the server S through the status information sending portion 808, hence returning to the step S1201.

As described above, the status information table 705 of the server S and the status information table 805 of the client X are updated one after another so as to keep the same information at all the time. Then, the user status information to be displayed on each of the user terminals is updated one after another.

Therefore, in accordance with the present embodiment, each user status information is shared by all the users between them so that a virtual office space is structured on the network with the same effect as an office space, for example, while implementing the distributed office system for the workers who execute their duties in the locations dispersed far away from each other without creating any sense of isolation or alienation even when each of the workers executes his or her duty in such geographically dispersed location continuously for a long time.

Also, when the image that represents the working condition of a worker, such image is displayed after having been processed with the processing intensity that corresponds to the interuser distance. Therefore, the sense of psychological resistance is not created with respect to the privacy protection, and an appropriate reciprocity is exercised between a user and other users, while keeping the symmetrical privacy protection between them.

### Second Embodiment

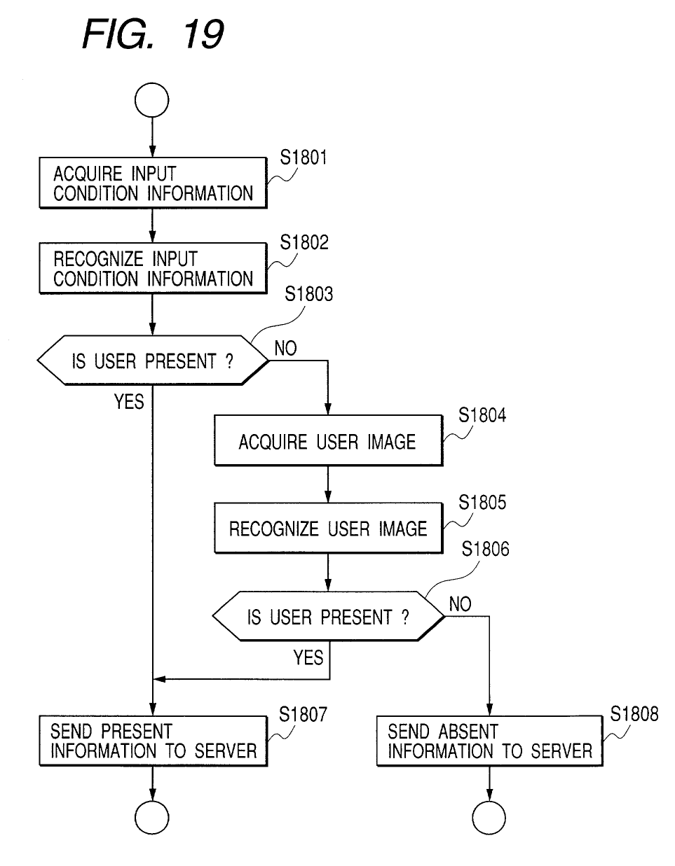

Next, with reference to FIG. 19, a second embodiment will be described in accordance with the present invention. FIG. 19 is a flowchart which shows the procedures of the main operation of the client X of the distributed system in accordance with the second embodiment of the present invention. In this respect, the structures of the present embodiment are the same as those of the first embodiment. Therefore, the description thereof will be omitted.

The present embodiment is different from the first embodiment in that the interuser distance (the organizational distance between users) is worked out in consideration of whether or not the user concerned is present in his or her designated location.

Now, the description will be made of the main operation of the client X in accordance with the present embodiment (the portion which differs from the first embodiment).

As shown in FIG. 19, for the client X of the present embodiment, the status information generating portion 803 actuates the input status acquiring portion 901 at first in step S1801 so that the input status acquiring portion 901 obtains the input status of the input device, such as the user key board. Then, in the following step S1802, the input status recognition portion 904 recognizes whether the user is present or absent in accordance with the input status obtained by the input status acquiring portion 901. Here, discrimination is made as to whether the input to the input device, for example, is made by the user intentionally or unintentionally by means of vibrations or the like. Then, depending on the result of such discrimination, the presence or absence of the user is recognized. Then, the process proceeds to step S1803 in which whether or not the presence of the user is recognized is determined in accordance with the result of such recognition by means of the input status recognition portion 904. If the presence of use is recognized, the process proceeds to step S1807 where the presence of user is notified to the server S.

In contrast, if the absence of user is recognized in the step S1803, the process proceeds to step S1804 where the input status acquiring portion 901 actuates the image acquiring portion 903, and the image acquiring portion 903 obtains the pictorial image of the user (still image or moving one). Then, in the following step S1805, the image recognition is made in the image recognition portion 906 in accordance with the pictorial image of the user thus obtained. Thus, the process proceeds to step S1806 where the recognition of user presence or absence is determined in accordance with the resultant recognition by the image recognition portion 906. Here, if the user presence is recognized, the process proceeds to step S1807 where the presence information is notified to the server S. If the user absence is recognized, the process proceeds to step S1808 where the absence information is notified to the server S.

The presence information or the absence information notified by the client X is inputted into the status information updating portion 704 of the server S. The status information updating portion 704 works out the organizational distance in consideration of the presence information or absence information thus inputted.

In the organization shown in FIG. 14, for example, if the user A who belongs to the A11 development section requests the server S for the pictorial image of the user B as the status information of the user B who belongs to the A12 development section which is among the same development division for which the user A works, the status information updating portion 704 discriminates the attendance (presence) status of the users A and B in accordance with the presence information or the absence information notified from the client of the user A and the client of the user B.

If both of the user A and user B are present in the designated locations, respectively, the organization distance between the user A and user B is worked out as “1” as in the case of the first embodiment described above. Then, corresponding to the interuser distance “1” thus worked out, the intensity of the filtering process is set at “1” for the pictorial image of the user B. Thus, for the pictorial image of the user B, the filtering process (mosaic treatment) of the intensity “1” is provided, and the pictorial image of the user B is transmitted to the user A after the filtering process of the intensity “1” (as shown in FIG. 16). In contrast, if either the user A or user B is recognized to be absent (actually, the user A who has requested the pictorial image should be present, while the user B is absent), the organizational distance is made smaller by 1 to be worked out as “0”. Then, corresponding to the organizational distance “0” thus worked out, the intensity of the filtering process is set at “0” for the pictorial image of the user B. In other words, the pictorial image of the user B which is not given any filtering process (as shown in FIG. 15) is transmitted to the user A.

When the user B belongs to the A21 development section of the same development center as the user A and both the user A and the user B are present, the organizational distance between the user A and user B is worked out as “2” as in the case of the first embodiment. Then, corresponding to the interuser distance “2” thus worked out, the pictorial image of the user B is given the filtering process the intensity of which is “2”. Then, the pictorial image of the user B which is given this filtering process (as shown in FIG. 17) is transmitted to the user A. In contrast, if either the user A or user B is recognized to be absent (actually, the user A who has requested the pictorial image should be present, while the user B is absent), the organizational distance is made smaller by 1 to be worked out as “1”. Then, corresponding to the organizational distance “1” thus worked out, the intensity of the filtering process is set at “1” for the pictorial image of the user B. The pictorial image of the user B which is given this filtering process (as shown in FIG. 16) is transmitted to the user A.

When the user B belongs to the B11 development section of the development center which is different from the one to which the user A belongs and both the user A and the user B are present, the organizational distance between the user A and user B is worked out as “3” as in the case of the first embodiment. Then, corresponding to the interuser distance of “3” thus worked out, the pictorial image of the user B is given the filtering process the intensity of which is “3”. Then, the pictorial image of the user B which is given this filtering process is transmitted to the user A. In contrast, if either the user A or user B is recognized to be absent (actually, the user A who has requested the pictorial image should be present, while the user B is absent), the organizational distance is made smaller by 1 to be worked out as “2”. Then, corresponding to the organizational distance “2” thus worked out, the intensity of the filtering process is set at “2” for the pictorial image of the user B. The pictorial image of the user B which is given this filtering process (as shown in FIG. 17) is transmitted to the user A.

As described above, in accordance with the present embodiment, the interuser distance (organizational distance) is worked out in consideration of whether the user is present or absent. Therefore, if the user is absent, it is possible to provide the pictorial image more clearly for the party on the requesting side at the time of the user being absence than the image at the time of the user being presence, hence making it easier to grasp the user environment when he or she is absent.

### Third Embodiment

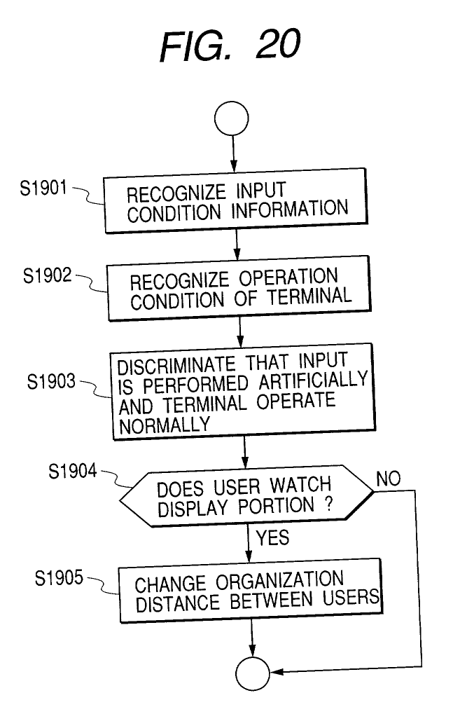

Next, with reference to FIG. 20, a third embodiment will be described in accordance with the present invention. FIG. 20 is a flowchart which shows the procedures of the main operation of the distributed system in accordance with the third embodiment of the present invention. In this respect, the structures of the present embodiment are the same as those of the first embodiment. Therefore, the description thereof will be omitted.

The present embodiment is different from the first embodiment in that the interuser distance (the organizational distance between users) is worked out in consideration of the information regarding whether or not the user concerned watches the display portion of the user terminal device (the display of a personal computer, for example).

Now, the description will be made of the main operation of the present embodiment (the portion which differs from the first embodiment).

As shown in FIG. 20, for the client X, the input status recognition portion 904 recognizes at first in step S1901 whether or not the user watches the display portion of the user terminal device in accordance with the input status acquired by the input status acquiring portion 901. Here, discrimination is made as to whether or not the input to the input device is intentionally and continuously made, for example. Then, depending on the result of such discrimination, whether the use watches the display or not is recognized. Then, in continuation, the process proceeds to step S1902 where the terminal operation recognition portion 905 recognizes whether the user terminal device is in operation normally in accordance with the terminal operation status acquired by the terminal operation acquiring portion 902. Then, the process proceeds to step S1903, it is determined whether or not the user watches the display portion in accordance with the recognized result of the input status recognition portion 904 and that of the terminal operation recognition portion 905. Here, if it is possible to obtain the result of recognition to ascertain that the user input to the input device is intentional and continuous, and also, the user terminal device is in operation normally, the user is found to be watching the display portion. When the user watches the display portion, the process proceeds to step S1905 where the interuser distance is changed by the status information updating portion 704 of the server S. If it is found in the step S1903 that the user is not watching the display portion, the process skips over the step S1905.

In the organization shown in FIG. 14, for example, if the user A who belongs to the A11 development section requests the server S for the pictorial image of the user B as the status information of the user B who belongs to the A12 development section which is among the same development division for which the user A works, the status information updating portion 704 discriminates whether or not each user watches the display in accordance with the contents of the client of the user A and the client of the user B, and works out the organizational distance between the users A and B.

If neither the user A nor the user B watches the display, the organizational distance between the user A and user B is worked out as “1” as in the case of the first embodiment described above. Here, then, corresponding to the interuser distance “1” thus worked out, the pictorial image of the user B is given the filtering process of the intensity “1”, and the pictorial image of the user B thus processed by this filtering process (as shown in FIG. 16) is transmitted to the user A. In contrast, if either one of the user A and the user B watches the display, the organizational distance is made smaller by 1 to be worked out as “0”. Then, corresponding to the organizational distance “0” thus worked out, the intensity of the filtering process is set at “0” for the pictorial image of the user B. In other words, the pictorial image of the user B which is not given any filtering process (as shown in FIG. 15) is transmitted to the user A.

When the user B belongs to the A21 development section of the same development center as the user A. and neither of the user A and user B are recognized to watch the display, the organizational distance between the user A and user B is worked out as “2” as in the case of the first embodiment. Then, corresponding to the interuser distance “2” thus worked out, the pictorial image of the user B is given the filtering process the intensity of which is “2”. Then, the pictorial image of the user B which is given this filtering process (as shown in FIG. 17) is transmitted to the user A. In contrast, if either the user A or user B is recognized to watch the display, the organizational distance is made smaller by 1 to be worked out as “1”. Then, corresponding to the organizational distance “1” thus worked out, the intensity of the filtering process is set at “1” for the pictorial image of the user B. The pictorial image of the user B which is given this filtering process (as shown in FIG. 16) is transmitted to the user A.

When the user B belongs to the B11 development section of the development center which is different from the one to which the user A belongs and neither of the user A and user B are recognized to watch the display, the organizational distance between the user A and user B is worked out as “3” as in the case of the first embodiment. Then, corresponding to the interuser distance of “3” thus worked out, the pictorial image of the user B is given the filtering process the intensity of which is “3”. Then, the pictorial image of the user B which is given this filtering process is transmitted to the user A. In contrast, if either the user A or user B is recognized to watch the display, the organizational distance is made smaller by 1 to be worked out as “2”. Then, corresponding to the organizational distance “2” thus worked out, the intensity of the filtering process is set at “2” for the pictorial image of the user B. The pictorial image of the user B which is given this filtering process (as shown in FIG. 17) is transmitted to the user A.

As described above, in accordance with the present embodiment, the interuser distance (organizational distance) is worked out in consideration of whether the user watches the display. Therefore, if the user watches the display, it is possible to provide the pictorial image more clearly at the time of watching the display more clearly than the image at the time of the user not watching the display, hence making it easier to grasp the environment of other users, while making it possible for the party to be observed to recognize the user who gives his or her attention to such party.

### Fourth Embodiment

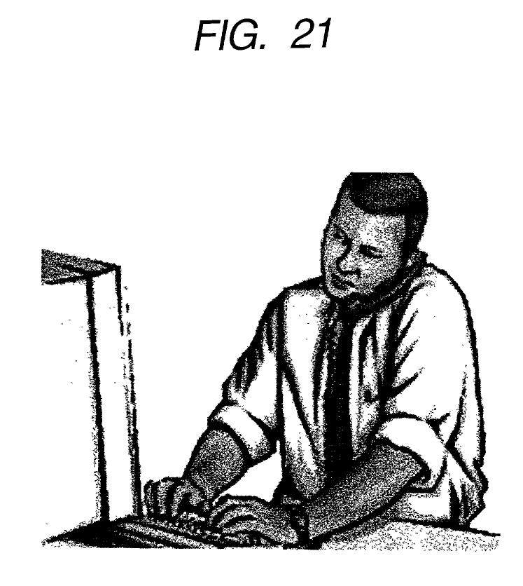

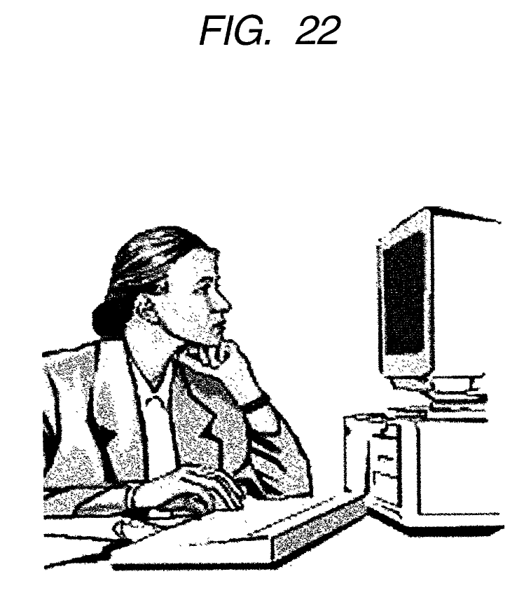

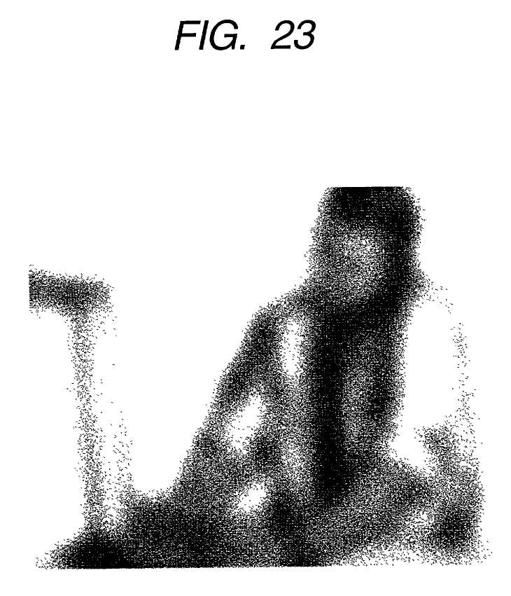

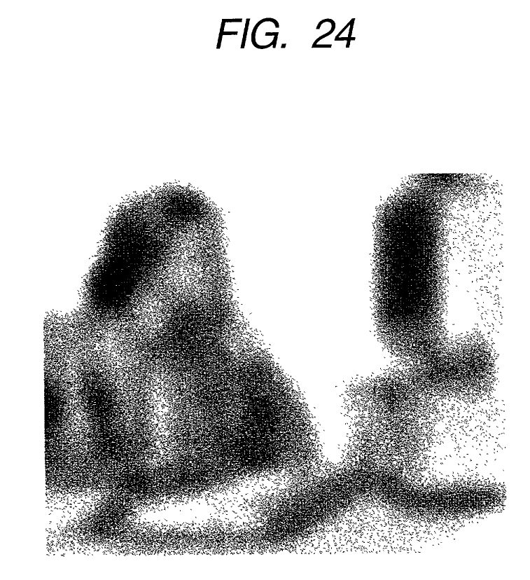

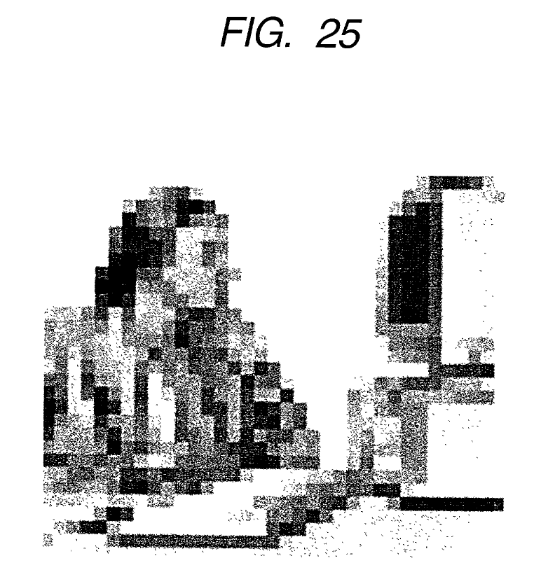

Next, with reference to FIG. 21 to FIG. 25, a fourth embodiment will be described in accordance with the present invention. FIG. 21 is a view which shows the example of a image-taken image of a user using one of the user terminal devices in the distributed system in accordance with the fourth embodiment of the present invention. FIG. 22 is a view which shows the example of a user pictorial image at the other user terminal device to be displayed on one of the user terminal devices after a gradation treatment is processed in accordance with the clarity of the user image-taken image represented in FIG. 21. FIG. 23 is a view which shows the example of another image-taken image of a user using one of the user terminal devices in the distributed system in accordance with the fourth embodiment of the present invention. FIG. 24 is a view which shows the example of a user pictorial image at the other user terminal device to be displayed on one of the user terminal devices after a gradation treatment is processed in accordance with the clarity of the user image-taken image represented in FIG. 23. FIG. 25 is a view which shows the example of a user pictorial image at the other user terminal device to be displayed on one of the user terminal devices after a mosaic treatment is processed in accordance with the clarity of the user image-taken image represented in FIG. 23. In this respect, the present embodiment is provided with the same structure as the first embodiment. Therefore, description of the structure will be omitted.

The present embodiment is different in that when the pictorial image of a user, which is image-taken by the cameras 65 and 66 installed for the other user's terminal device, is displayed on the screen of the display portion of one user's terminal device in accordance with the first embodiment described above, the interuser distance is worked out between one user's terminal device and the other user's terminal device in accordance with the clarity of the pictorial image of the user image-taken by the cameras 65 and 66 installed on one user's terminal device. Here, the interuser distance is worked out by the application of a designated coefficient so that it becomes smaller as the clarity becomes higher for the pictorial image of the user image-taken by one user's terminal device.

Next, with reference to FIG. 21 to FIG. 24, the description will be made of the status information updating portion 704 of the present embodiment.

When the user A requests the server S for the pictorial image of the user B as the status information of the user B, for example, the status information updating portion 704 works out the interuser distance in accordance with the clarity of the pictorial image of the user A image-taken by the user terminal device of the user A, and corresponding the interuser distance thus worked out, the image process is given to the pictorial image of the user B. Then, the control is made to display the pictorial image of the user B on the screen of the user terminal device of the user A after such image process has been executed. The image process is such as a mosaic treatment, a gradation, or other filtering process. The intensity of the filtering process is set so that the larger the interuser distance, the grater becomes the intensity thereof. Also, the interuser distance is worked out by the application of a predetermined coefficient to make it smaller as the clarity becomes higher.

For example, if the user A requests the server S for the pictorial image of the user B as the status information of the user B, the status information updating portion 704 works out an interuser distance between the user A and user B corresponding to the clarity of the user image of the user A who is the requesting party of the current user pictorial image. Here, it is assumed that the user image of the user A who is the requesting party of the current user pictorial image is the one (image-taken by the cameras 65 and 66) which has the clarity as shown in FIG. 21, for example. Then, “0” is worked out as the clarity of the user image of the user A, and the interuser distance is worked out to be “0” corresponding to the clarity “0” thus worked out. For this interuser distance “0”, the intensity of filtering process is set at “0” for the pictorial image of the user B. The intensity “0” of the filtering process indicates that no filtering process is executed. Therefore, no filtering process (here, the gradation treatment) is given to the pictorial image of the user B. In this respect, it is assumed that the larger the value of intensity of filtering process, the larger becomes the degree of the filtering process. Here, the pictorial image of the user B, which is not given any filtering process, is transmitted to the user A. For example, if a pictorial image shown in FIG. 22 is obtained as the pictorial image of the user B (image-taken by the cameras 65 and 66), the pictorial image shown in FIG. 22 is transmitted to the user A without giving any filtering process.

Also, if the user image of the user A who is the requesting party of a pictorial image of a user is the pictorial image having the clarity as shown in FIG. 23, for example, the clarity of this user pictorial image of the user A is worked out as “1”, and the interuser distance is worked out to be “1” corresponding to the clarity “1” thus worked out. For this interuser distance “1”, the intensity of filtering process is set at “1” for the pictorial image of the user B. Then, the filtering process (here, the gradation treatment) of the intensity “1” is given to the pictorial image of the user B, and the pictorial image of the user B, which is given the filtering process of the intensity “1”, is transmitted to the user A. For example, if a pictorial image shown in FIG. 22 is obtained as the pictorial image of the user B, this pictorial image is given the filtering process of the intensity “1” (here, the gradation treatment), thus obtaining the pictorial image shown in FIG. 24. This pictorial image of user B is transmitted to the user A after the execution of the intended filtering process.

As regards the clarity of a user image, the edge amount of the user image is worked out by use of a high-pass filter, such as Sobel filter. Then, with the total sum of the absolute values of edge amounts thus worked out, the clarity thereof is determined. For example, the way of calculation is arranged so that the greater the total sum of the absolute values of edge amounts worked out for a user image, the higher becomes the clarity of the user image, and then, it is determined that the higher the clarity of such user image, the smaller becomes the value of the interuser distance. When working out this clarity of user image, it may be possible to arrange the structure to execute a noise process so that the absolute values are not added to the total sum in order to reduce the noise influence that may be exerted on the image-taken user pictorial image if the absolute values of the edge amounts should become smaller than a threshold value.

Also, if the pictorial image of a user is coded by means of conversion encoding, such as using wavelet conversion, discrete cosine conversion, it may be possible to determine the clarity with the total sum of conversion coefficient of high frequency. In this case, for example, the calculation is made so that the larger the total sum of the conversion coefficient of high frequency worked out for the pictorial image of a suer, the higher becomes the clarity of this user image, and that the value of the interuser distance is determined to be smaller as the clarity of this user image becomes higher.

Also, conversely, when the user B requests the pictorial image of the user A as the status information of the user A, the interuser distance between the user A and user B is worked out in accordance with the clarity of the user image of the user B who is the requesting party of this pictorial image of the user B. Then, corresponding to this interuser distance, the filtering process is given to the pictorial image of the user A. The pictorial image of the user A is transmitted to the user B after having executed this filtering process.

As described above, when the user A requests the server S for the pictorial image of the user B as the status information of the user B, for example, the distance between the user A and user B by the degree of clarity is worked out, and the pictorial image of the user B is given an image process in accordance with the distance by the degree of clarity thus worked out. Then, the control is made to display on the screen of the user terminal device of the user A the pictorial image of the user B after the image process has been executed. Therefore, if the user intentionally sets the cameras 65 and 66 out of focus or covers the cameras 65 and 66 in order to make the pictorial image of the user own unclear intentionally, the pictorial image of other user (the user B, for instance) is given a filtering process accordingly to make the image thereof unclear when being displayed. In this way, the symmetrical privacy protection is maintained between the user A and user B to provide an appropriate reciprocity for each of the users A and B.

In this respect, for the present embodiment, the gradation treatment is exemplified as the image process that corresponds to the interuser distance. However, in place of this treatment, it may be possible to use the mosaic treatment as the image process as shown in FIG. 25, for example. This example is such that the clarity of the pictorial image of the user A is worked out to be “1”, and that the pictorial image of the user B shown in FIG. 22 is given the mosaic treatment of the intensity “1”.

Also, for the present embodiment, the interuser distance is worked out corresponding to the clarity of the user image, but it may be possible to arrange the structure so that the user A requests the user B that the interuser distance that depends on the degree of clarity between the user A and user B should be changed when the pictorial image of the user B is requested, and that if the user B accepts such particular request, the interuser distance that depends on the degree of clarity can be changed to the interuser distance as request by the user A. For example, when the interuser distance is “3” in accordance with the degree of clarity between the user A and user B, the use A can request the user B that the interuser distance should be made smaller than the “3” if the user A wishes to receive the display of the pictorial image of the user B after changing the value of the interuser distance to be smaller than the “3”. Then, if the user B accepts this particular request, the interuser distance is made smaller, thus lowering the barrier of the bilateral (symmetric) privacy protection between the users A and B.

### Fifth Embodiment

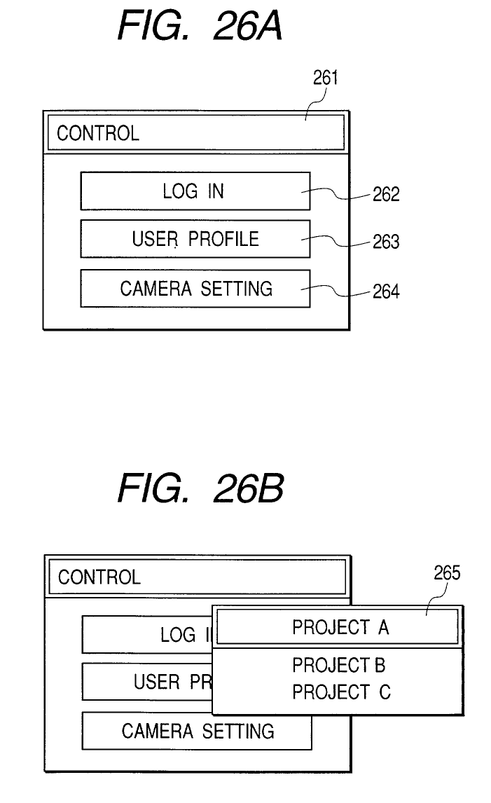

Next, with reference to FIGS. 26A and 26B to FIG. 33, the description will be made of a fifth embodiment in accordance with the present invention. Here, the present embodiment is provide with the same structures as those of the first embodiment. Therefore, the description of such structures will be omitted.

At first, the user selects the virtual space that he or she logs in. Here, it is assumed that a plurality of usable virtual spaces are provided in advance for the host server device 11, and that the arrangement is made to allow the user concerned to log in such virtual spaces. The control of each kind of the virtual space, the user access information, and the like are managed by the utilization of the data base 53 (see FIG. 4) on the host server device 11. Now, with reference to FIGS. 26A and 26B, the log-in operation will be described.

FIGS. 26A and 26B are the log-in dialogues indicated on the display 64 of the user terminal device 15.

A reference numeral 261 designates the control panel used for operating the log-in; 262, a button for initiating the log-in operation; 263, a button for initiating the menu for changing the user profile to be registered on the host server device 11; and 264, a button for initiating the menu set for the parameters of the camera used for the image communications. When the user depresses the log-in initiation button 262, the sub-menu 265 appears for the selection of the virtual space to be logged in. In this case, it is indicated that three spaces can be logged in by the user concerned. The user designates one virtual space from among those shown on the sub-menu 265 to be able to log in the virtual space thus designated.

When the virtual office which is the designated virtual space is logged in, all the pieces of information regarding the user concerned, such his or her pictorial image, messages, among some others, are distributed to all other users residing in such office by way of the host server device 11.

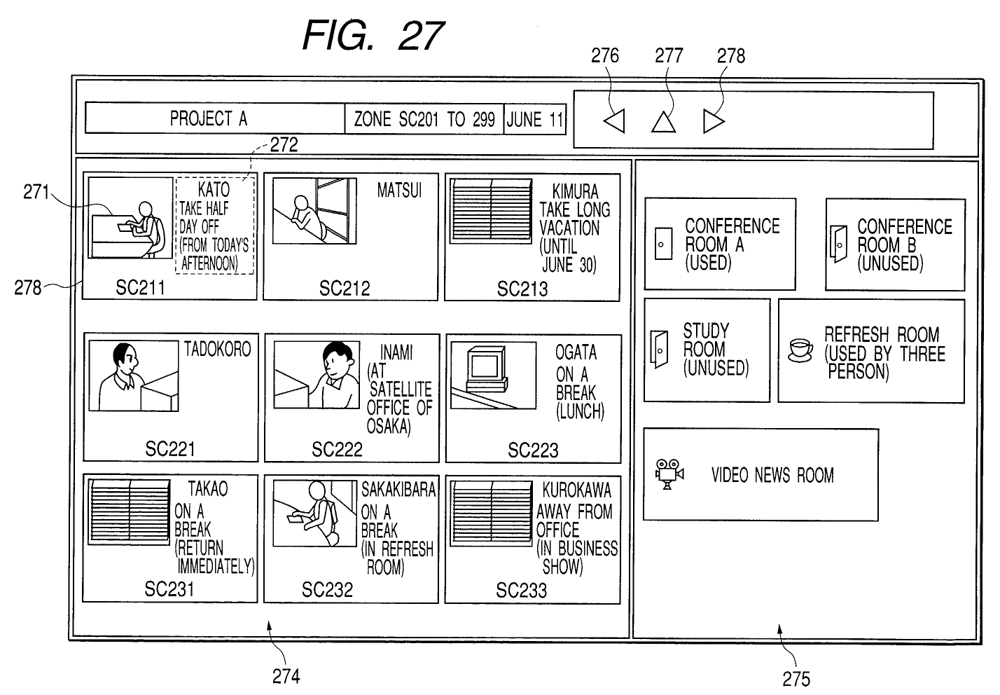

FIG. 27 is a view which shows the virtual space screen called the office view which is indicated on the display 64 of the user terminal device 15.

A reference numeral 271 designates an image that represents the working condition of a user (Katoh); 272, the working status data indicating portion where the written information, that is, the data on the working condition of the user concerned, is shown; and 273, the private office space for the user concerned. These three pictorial portions 271 to 273 form in combination the virtual private office of the user concerned. In this respect, for the present embodiment, nine private offices are indicated on the same screen, but the number of private offices may be more or less than the one indicated here. Then, the entire space indicated at 274 is arranged to be the area of the private offices. Also, each space between one private office and the adjacent one is a corridor virtually provided.

The pictorial image 271 that shows the working condition of a user as a part of the private office is the one image-taken by a camera (equivalent to the one at 65 or 66) provided for the user terminal device used by such user. The pictorial image data shown on the image 271, and the written information of the working condition indicated on the display portion 272 are transmitted to the host server device 11 from the user terminal device, and the host server device 11 distributes such data to the other users residing in the same virtual space.

Here, at the same time that a user logs in the designated virtual space for the present embodiment, the information regarding such user is distributed to a plurality of other virtual offices which are redetermined. In the case represented in FIGS. 26A and 26B, the virtual office for the project A is logged in, the presence information is provided for the virtual office for the project B and the project C simultaneously.

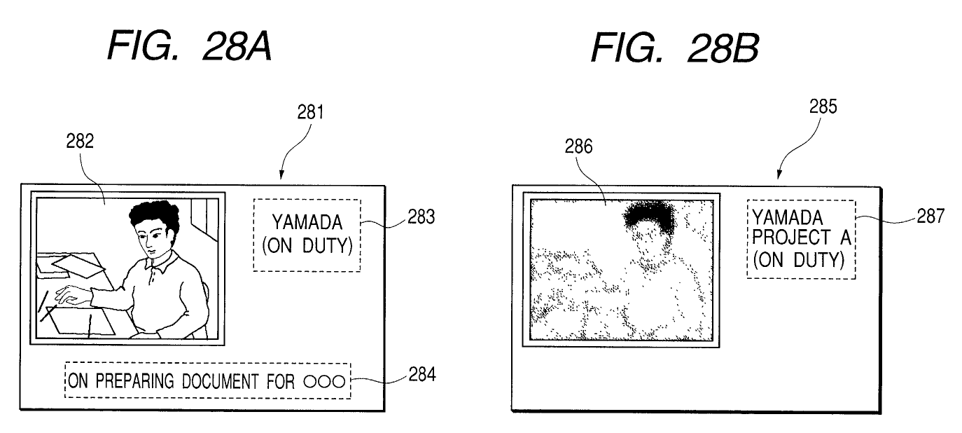

This simultaneous representation system will be described in detail with reference to FIGS. 28A and 28B.

FIGS. 28A and 28B are views which illustrate the private office space of the user “Yamada” who is present in the virtual office space (office view), which are shown on the screens on the displays of the user terminal devices of the other users who are also present in the virtual office space concerned. Here, the user “Yamada” belongs to the project A, project B, and project C, and the description is made of the case where the project A is currently logged in. FIG. 28A shows the screen displayed on the other user's terminal device concerning with the project A. FIG. 28B shows the screen to be shown on the screen of other users' terminal devices concerning with the project B and project C.

In FIG. 28A, a reference numeral 281 designates the private office space of the user “Yamada” being present in the project A; 282, the pictorial image of user “Yamada”; 283, a fixed form that indicates the working condition of user “Yamada”; and 284, a free message that user “Yamada” may provide.

On the other hand, in FIG. 28B, a reference numeral 285 designates the private office space of the user “Yamada” which is shown on the user terminal of each of the other users concerned with the project B and project C to which the user “Yamada” also belongs, but not logs in them currently; and 286, the pictorial image of user “Yamada”: in this case, the information amount of the pictorial data is curtailed by means of the spatial filtering process on the host server device 11 side so that the image information is shown in the minimum status where only the presence of the user “Yamada” is recognizable. Also, in the region of a fixed message at 287, a message, in which is added the information of the project currently logged in, is indicated in addition to the fixed message at 283. The free message at 284 is not shown on any other projects if such message is made effective only within a project currently in operation.

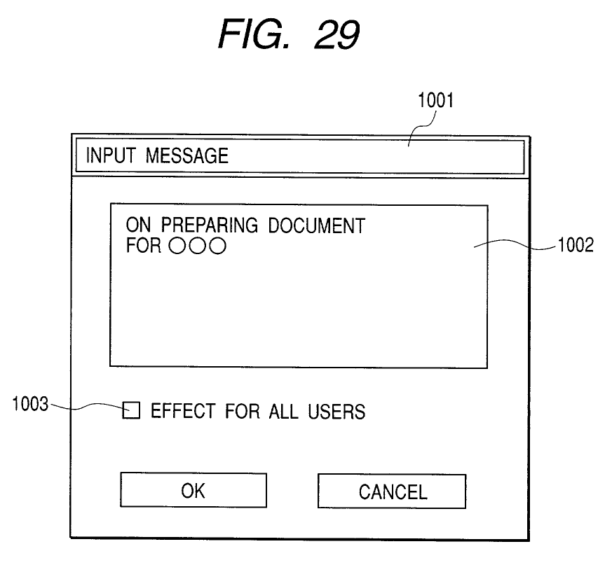

FIG. 29 is a view which shows the free message input dialogue 1001 to be indicated on the display 64 of the user terminal device 15 when the user “Yamada” inputs his free message on the user terminal device 15 by use of the key board 63.

Here, a reference numeral 1002 designates a message input area; 1003, a check box to designate the user range where the free message can be indicated. When a check mark is given to the check box 1003, it becomes possible to provide the current message in the message input area 1002 for the users in the projects which are not currently logged in (here, the project B and project C). If no check marks is given, the message inputted into the message area 1002 is distributed to only the users concerning with the currently logged-in project.

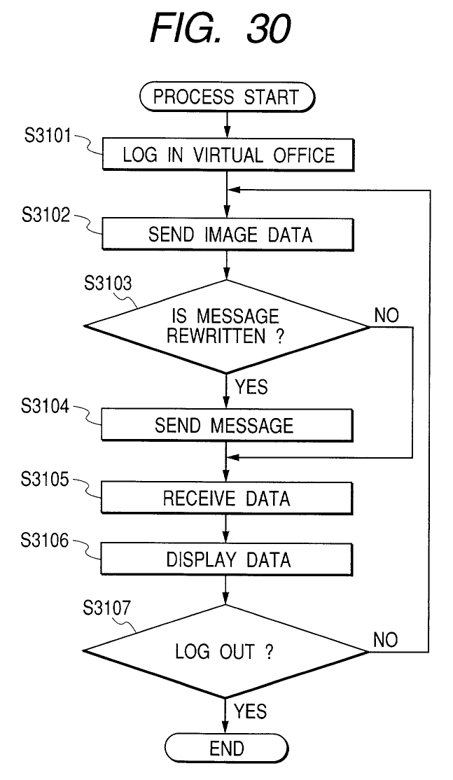

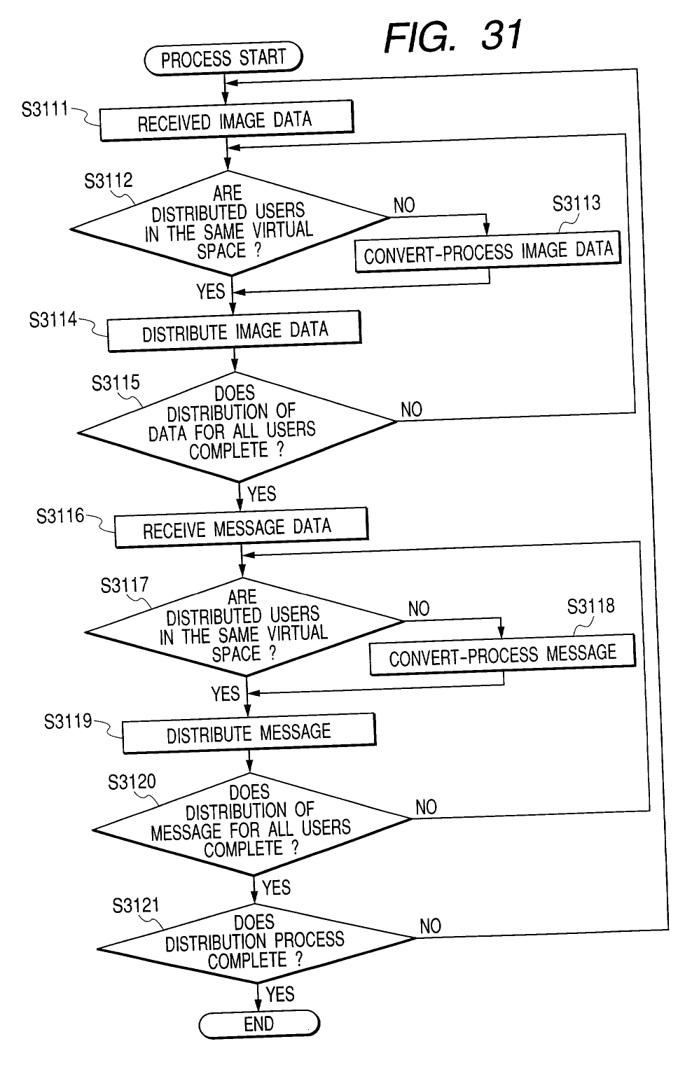

Next, with reference to FIG. 30 and FIG. 31, the description will be made of the operation of the virtual space system in accordance with the present embodiment.

FIG. 30 is a flowchart which shows the operational procedures in the user terminal device. Hereinafter, exemplifying the user terminal device 15 the description will be made.

When the user of the user terminal device 15 to log in the virtual office (step S3101) and begins working, the user terminal device 15 begins transmitting pictorial image data (step S3102). Through the video device of the personal computer main body 61, the pictorial image data are inputted by each of the video cameras 65 and 66 into the personal computer 22, and fetched in as digital image of QCIF format (176×144 pixels). Then, after being compressed into codes by means of the JPEG or H.263 image encoding method, or the like, the pictorial image data are transmitted to the host server device 11. Also, simultaneously, the fixed message 903 and the free message 284 (see FIG. 28A) are transmitted to the host server device 11.

Next, it is determined whether or not the fixed message 283 and the free message 284 (see FIGS. 28A), which are notified to the other users, are changed (step S3103). If affirmative, the messages are transmitted to the host server device 11 after changes (step S3104).

Next, the user terminal device 15 receives the data that contains the pictorial image and messages from the host server device 11 (step S3105), and displays them on the display 64 of the user terminal device 15 (step S3106). In the processes in the steps here, the office view screens are generated as shown in FIGS. 28A and 28B.

The processes described above are repeated until the user logs out (step S3107).

FIG. 31 is a flowchart which shows the operational procedures of the host server device 11.

The host server device 11 receives the pictorial image data transmitted from the user (step S3111). Then, corresponding to the users on the distributing destinations (step S3112), the pictorial image data are distributed. In other words, if a user on a distributing destination is present in the same virtual space as the virtual space logged in by the distributing party of the pictorial image data, the pictorial image data is distributed to the user terminal device on the distributing destination as it is (step S3114). On the other hand, if the user on the distributing destination is present in the virtual space which is different form the virtual space logged in by the use who distributes the user's pictorial image data, the pictorial image data are changed as given below (step S3113), and distributed to the user terminal device on the distributing destination (step S3114).

In the step S3113, the information amount of the pictorial image data is curtailed by means of the low pass filtering process or the like which enables the high frequency component of the pictorial image data to be reduced. A converting process of the kind is executed at high speed by use of the signal processing unit (SPU) 32 incorporated in the host server device 11. The low pass filtering process here is the spatial filtering process which is generally practiced conventionally.

The processes described above are executed for all the users on the distributing destinations who correspond one to one to the user who distributes the pictorial image data (step S3115).

Next, the host server device 11 received the message data transmitted from the user (step S3116), and corresponding to the users on the distributing destinations (step S3117), the message data are distributed. In other words, if the user on the distributing destination is present in the same virtual space as the user who transmits the message, the message data is transmitted to the user terminal device on the distributing destination as it is (step S3119). On the other hand, if the user on the distributing destination is present in the virtual space which is different from the one in which is present the user who distributes the message, the message is changes as given below (step S3118), and distributed to the user terminal device of the user on the distributing destination (step S3119).

In the step S3118, the name of project currently logged in by the user who transmits the message is added to the fixed message 283 shown in FIG. 28A as the fixed message 287 shown in FIG. 28B. Also, if no check mark is given to the check box 1003 of the input dialogue 1001 shown in FIG. 29, the free message 1002 is deleted from the message data.

The processes described above are executed for all the users on the distributing destinations who correspond one to one to the user on the transmitting side (step S3120). In this respect, any one of the information described above is not distributed to the users who are not directly related to the user on the distributing side (that is, the users who do not belong to the virtual space established in advance by the user on the distributing side).

When the above processes are completed, the distributing process by the host server device 11 terminates (step S3121).

As described above, in accordance with the present embodiment, it is possible for the user who belongs to plural groups for executing his or her duty to provide the presence information to all the users belonging to such groups (both the users of the group which is currently logged in, and the users who belong to the groups other than that group), and also, to provide the communicating information for members of all the groups to which the user belongs, hence securing a sense of unity among such groups. Also, simultaneously, the distributing information is limited in distributing it to the other users on the virtual space which is not logged in by the user concerned, thus reducing the unwanted occupation of the communication band by the distribution of the unnecessary data, while preventing the distribution of any information which should be kept unknown to the user in the virtual spaces which are not logged in currently.

### Sixth Embodiment

For the distributing control of the pictorial image data in accordance the embodiment described above, the spatial filtering process is executed in order to curtail the information amount of the pictorial image data in the step S3113. However, the present invention is not necessarily limited thereto. It may be possible to execute some other image process to curtail the information amount of the pictorial image data. For example, there are processes that can be utilized in this respect, such as to lower the frame rate, to curtail the pixel numbers for distribution, to process the mosaic representation, and to convert the pictorial image data into the monochromatic data for distribution, among some others.

Also, in accordance with the embodiments described above, the natural image image-taken by the video cameras 65 and 66 is utilized as the pictorial image data. However, in place of such natural image, it may be possible to utilize an artificially created image data by use of the three-dimensional CG or the like. In this case, the image data converting process portion processes the curtailment of the polygonal numbers or the like.

Also, in the step S3118 in the previous embodiment, the free message is curtailed in order to reduce the information amount of message data. However, the present invention is not necessarily limited to this curtailment. It may be possible to execute various curtailment processes for the information amount of the message data in accordance with the application to be utilized.

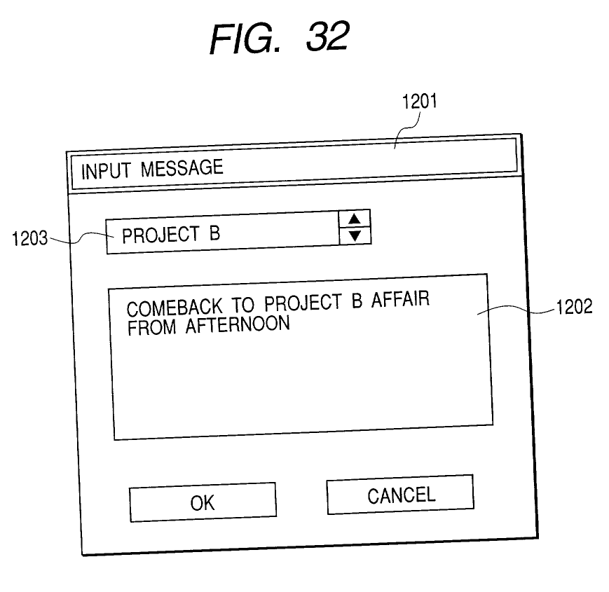

Also, for the embodiment described above, it is determined whether or not the free message 1002 is deleted from the message data to be transmitted to the virtual spaces other than the one currently logged in by means of the contents of the check box 1003 in the input dialogue 1001 in FIG. 29. However, in place of this method, it may be possible to determine whether or not the free message is deleted from the message data to be transmitted to such virtual spaces per each of the virtual spaces which can be logged in. Further, it may be possible to present the message data having different free message 1002 per each of the virtual spaces that can be logged in. These events will be described with reference to FIG. 32.

FIG. 32 is a view which shows the input dialogue 1201 for indicating different free messages per virtual space capable of being logged in.

Here, a reference numeral 1202 designates the massage input area for inputting free messages, and 1203, a list box for selecting the virtual space to show the free message inputted into the message input area 1202 is shown. In FIG. 32, it is designated that the free message inputted into the message input area 1202 should be shown only for the user who logs in the project B. In this case, it becomes possible to show free messages on real time to the user in the virtual space arbitrarily selected without logging in the other virtual space.

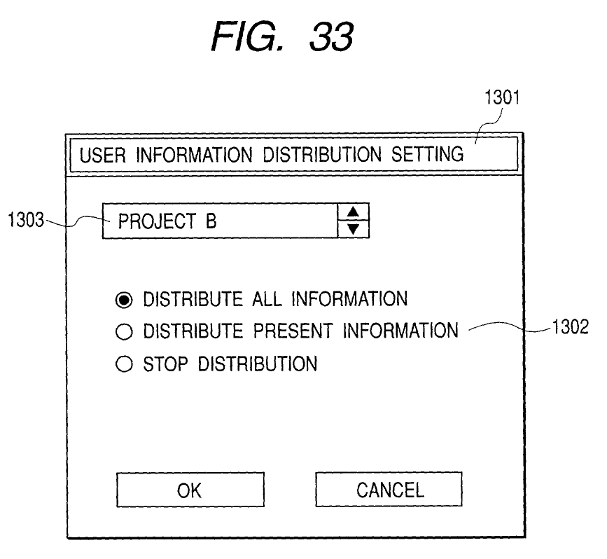

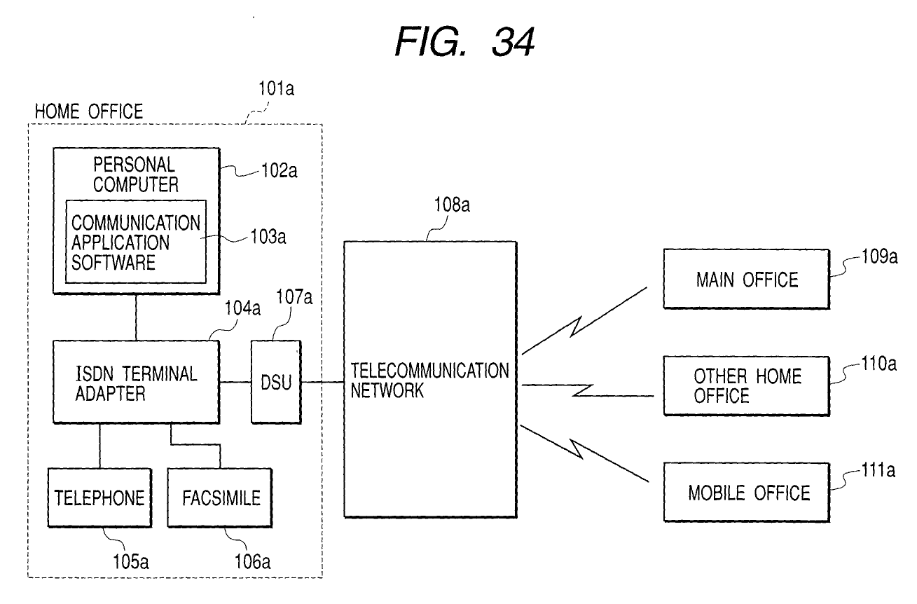

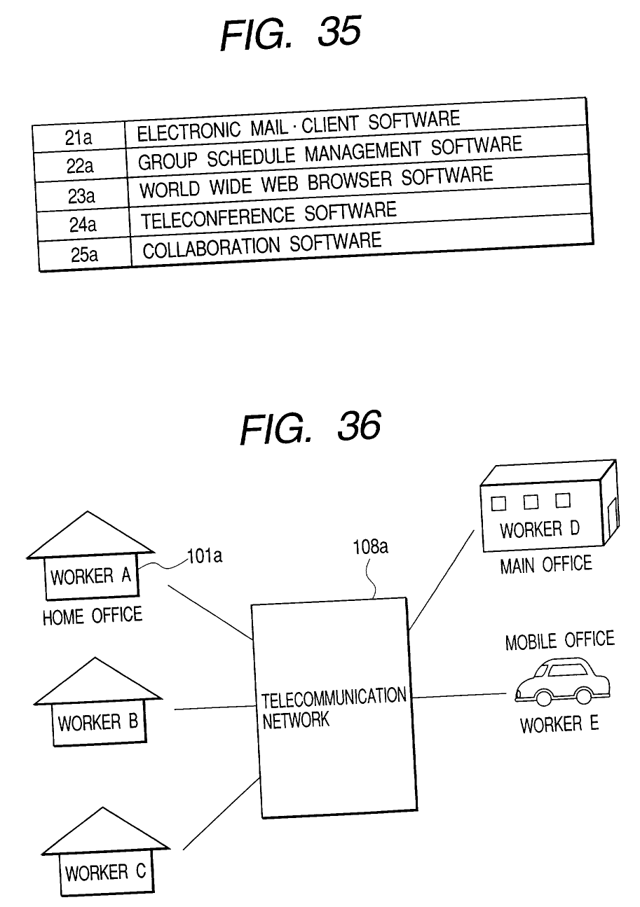

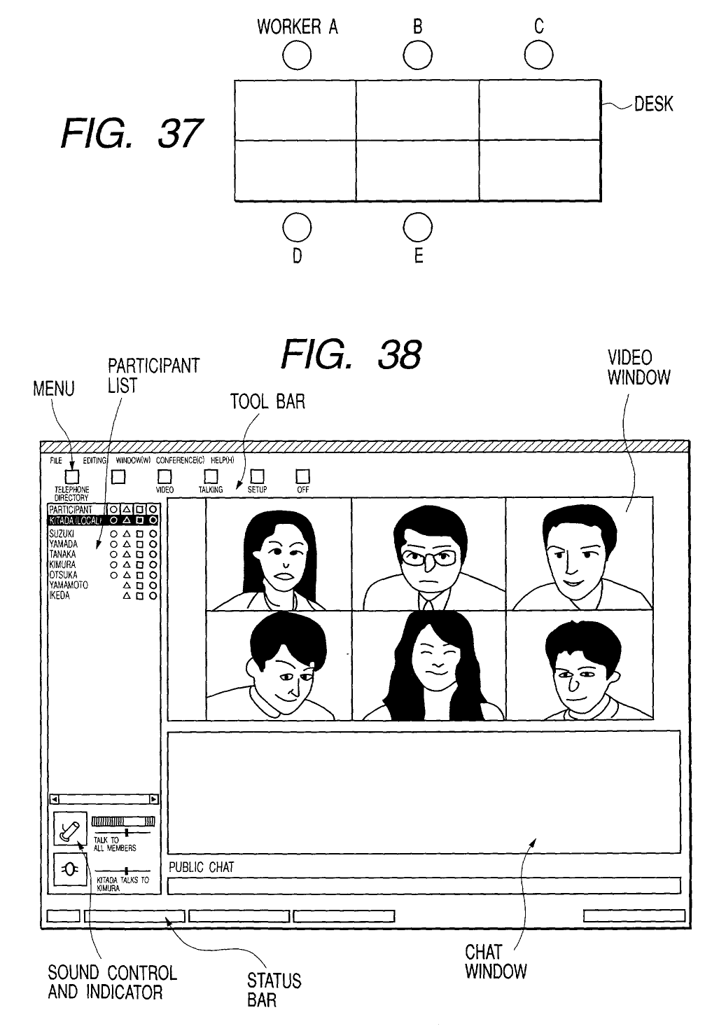

Further, it may be possible to restrict the user information to be distributed per virtual space capable of being logged in. Now, with reference to FIG. 33, this set up will be described.

FIG. 33 is a view which shows the input dialogue 1301 for designating the user information to be distributed per virtual space of being logged in.

Here, a reference numeral 1303 designates the list menu for selecting the virtual space for the designated object and 1302, each radio button for designating the kind of user information to be distributed in the virtual space selected by the list menu 1303. In FIG. 33, it is designated that all the user information should be distributed to the users who have logged in the virtual space of the project B. In this case, it becomes possible to designate the kind of user information to be distributed per virtual space. For example, depending on the relationship between projects, the distributing conditions can be determined for the user information.

Also, in accordance with the embodiments described above, it is arranged to exchange the pictorial image of users wit each other in the virtual space, but it may be arranged so that the embodiments can be applied to the case where only the text data are exchanged with each other in the virtual space. Further, it may be possible to adopt a method other than those described in the above embodiments for showing the pictorial image data and the text data.

Also, for the embodiments described above, the description has been made of the virtual space system by exemplifying the virtual office system, but the present invention is not necessarily limited to such applications. It may be possible to apply the present invention to various virtual spaces to be built on the network.

Also, in accordance with the embodiments described above, the host server device 11 execute the conversion of user information, but in place thereof, it may be possible to structure the arrangement so that the user terminal device executes the conversion of user information in accordance with the related instruction from the host server device 11.

Also, it may be possible to store in advance on the server device the information that designates a plurality of virtual spaces where one user can reside simultaneously.

In this respect, for the embodiments described above, the mosaic treatment or the gradation treatment is exemplified as the filtering process, but the present invention is not necessarily limited thereto. It may be possible to use noise adding process, monochromatic process, color half tone process, line drawing process or the like or the combination thereof, among some others.

Also, for each of the embodiments described above, the interuser distance is worked out in the server device 11, and the filtering process is given to the pictorial image of a user with the intensity that corresponds to the interuser distance thus worked out. it may be possible to arrange the structure so that the interuser distance can be worked out in each of the user terminal devices, and that the filtering process is executed with the intensity that corresponds to the interuser distance thus worked out. In this case, the load exerted on the host server device 11 can be reduced.

Further, for each of the embodiments described above, the distributed office system is structured, and the organizational distance or the distance that corresponds to the clarity of a user pictorial image is worked out as the interuser distance concerned. For example, however, it may be passible to adopt the physical distance between the corresponding user terminal devices for the interuser distance. Also, when a virtual space is formed to reside each of the user terminal devices therein, the interuser distance may be defined by a distance between the corresponding user terminal devices in the virtual space.

Further, it may be possible to change the interuser distance in accordance with the result of status recognition, such as the degree of the pressure under which a user should work, and the voice recognition, among some others.

Further, it is of course possible to achieve the objectives of the present invention by supplying the storage medium, on which are recorded the programming codes of software to implement the functions of each of the embodiments described above (including the flowcharts shown in the FIG. 12, FIG. 13, FIG. 19, and FIG. 20), to the system or device in order to enable such system or the computer (or CPU or MPU) of the device to read out and execute the programming codes stored on such storage medium.

In this case, the programming codes themselves thus read out from the storage medium implement the functions of the embodiments described earlier, and the storage medium that stores the programming codes thereon is construed to constitute the present invention.

As a storage medium for storing such programming codes, it is possible to use a floppy (R) disc, a hard disc, an optical disc, an optomagnetic disc, a CD-ROM, a CD-R, a magnetic tape, a non-volatile memory card, a ROM, or the like, for example.

Also, the present invention is of course construed to include not only the case where the functions of the aforesaid embodiments are implemented by a computer that executes the programming codes thus read out, but also, include the case where the operating system (OS) or the like that operates on the computer executes partly or totally the actual processes in accordance with the instructions from the programming codes so as to implement the functions of the aforesaid embodiments by the processes thus executed.

Further, the present invention is of course construed to include the case where the programming codes thus read in are once written on the expanded functional board or on the memory provided for the expanded functional unit connected with the computer, and then, the actual processes are executed partly or totally by the CPU or the like provided for such expanded functional board or functional storage unit in accordance with the instructions contained in the programming codes, hence implementing the functions of the aforesaid embodiment by the processes thereof.

What is claimed is:

1. A distributed system provided with a plurality of user terminal devices having image-taking means and displaying means, and a server device connected with said plurality of user terminal devices through communication lines, comprising:
user status recognition means for recognizing the status of user in use of said terminal devices per user terminal device; and
control means for controlling the display of user status on the other user terminal devices for said displaying means per user terminal device, wherein
when the pictorial image of a user image-taken by image-taking means of the other user terminal device is displayed on one of the user terminal devices among each of said user terminal devices, said control means works out the interuser distance between said one of user terminal devices and said other user terminal device, and controls the display of the pictorial image of the user on said other user terminal device for said displaying means of said one of user terminal devices in accordance with said interuser distance thus worked out.

2. A distributed system according to claim 1, wherein each of said user terminal devices is set within an organization having plural places of duty, and the interuser distance between one of said user terminal devices and said other user terminal device is a distance in terms of said organization.

3. A distributed system according to claim 1, wherein said interuser distance is the physical distance between said one of user terminal devices and said other user terminal device.

4. A distributed system according to claim 1, wherein each of said user terminal devices is set within a virtual space, and said interuser distance between said one of user terminal devices and said other user terminal device is a distance in terms of said virtual space.

5. A distributed system according to claim 1, wherein when the pictorial image of a user image-taken by image-taking means of the other user terminal device is displayed on one of the user terminal devices among each of said user terminal devices, said control means works out the interuser distance between said one of user terminal devices and said other user terminal device corresponding to the clarity of pictorial image of the user image-taken by image-taking means of said one of user terminal devices.

6. A distributed system according to claim 5, wherein said interuser distance is worked out to be smaller as the clarity of pictorial image of the user image-taken by image-taking means of said one of user terminal devices of said user becomes higher.

7. A distributed system according to claim 1, wherein said control means executes the image process for the user pictorial image of said other user terminal device corresponding to said interuser distance, and displays on displaying means of said one of user terminal devices the pictorial image of the other user after the execution of said image process.

8. A distributed system according to claim 7, wherein said image process is a filtering process having an intensity corresponding to said interuser distance.

9. A distributed system according to claim 8, wherein said filtering process is a process using mosaic treatment, gradation treatment, or the like.

10. A distributed system according to claim 8, wherein the intensity of said filtering process becomes higher as said interuser distance becomes greater.

11. A distributed system according to claim 1, wherein said user status recognition means comprises input status recognition means for recognizing the status of input from each user of said user terminal devices; terminal operating status recognition means for recognizing the operating status of each of said user terminal devices; and image recognition means for recognizing the pictorial image of the user image-taken by image-taking means of each of said user terminal devices, and said control means changes said interuser distance in accordance with the user status of said one of user terminal devices obtained by at least one combination or more of the result of each recognition given by said input status recognition means, said terminal operating status recognition means, and said image recognition means.

12. A distributed system according to claim 1, further comprising:
designated interuser distance input means for inputting a designated interuser distance by the user operation, wherein
said control means controls said interuser distance to turn into said designated interuser distance when said designated interuser distance is inputted by said designated interuser distance input means.

13. A distributed system according to claim 1, wherein said user status recognition means is provided either for said user terminal device or said server device.

14. A distributed system according to claim 1, wherein said control means is provided either for said user terminal device or said server device.

15. A method for controlling the display of a distributed system provided with a plurality of user terminal devices having image-taking means and displaying means, and a server device connected with said plurality of user terminal devices through communication lines, comprising the following steps of:
recognizing the status of user in use of said terminal devices per user terminal device;
displaying the user status of the other user terminal device on said displaying means per user terminal device; and
working out the interuser distance between said one of user terminal devices and said other user terminal device when the pictorial image of the user image-taken by image-taking means of the other user terminal device is displayed on displaying means of said one of user terminal devices among each of said user terminal devices, and controlling the display of the pictorial image of user of said other user terminal devices for said displaying means of said one of user terminal devices in accordance with said interuser distance thus worked out.

16. A method for controlling the display of a distributed system according to claim 15, wherein each of said user terminal devices is set within an organization having plural places of duty, and the interuser distance between one of said user terminal devices and said other user terminal device is a distance in terms of said organization.

17. A method for controlling the display of a distributed system according to claim 15, wherein said interuser distance is a physical distance between said one of user terminal devices and said other user terminal device.

18. A method for controlling the display of a distributed system according to claim 15, wherein each of said user terminal devices is set within a virtual space, and said interuser distance between said one of user terminal devices and said other user terminal device is a distance in terms of said virtual space.

19. A method for controlling the display of a distributed system according to claim 15, wherein when the pictorial image of a user image-taken by image-taking means of the other user terminal device is displayed on one of the user terminal devices among each of said user terminal devices, the interuser distance between said one of user terminal devices and said other user terminal device is worked out in said controlling step corresponding to the clarity of pictorial image of the user image-taken by image-taking means of said one of user terminal devices.

20. A method for controlling the display of a distributed system according to claim 19, wherein said interuser distance is worked out to be smaller as the clarity of pictorial image of the user image-taken by image-taking means of said one of user terminal devices of said user becomes higher.

21. A method for controlling the display of a distributed system according to claim 15, wherein the image process for the user pictorial image of said other user terminal device is executed corresponding to said interuser distance, and on displaying means of said one of user terminal devices, the pictorial image of the other user is displayed after the execution of said image process.

22. A method for controlling the display of a distributed system according to claim 21, wherein said image process is a filtering process having an intensity corresponding to said interuser distance.

23. A method for controlling the display of a distributed system according to claim 22, wherein said filtering process is a process using mosaic treatment, gradation treatment, or the like.

24. A method for controlling the display of a distributed system according to claim 22, wherein the intensity of said filtering process becomes higher as said interuser distance becomes greater.

25. A method for controlling the display of a distributed system according to claim 15, comprising the following steps of:
recognizing the status of input from each user of said user terminal devices;
recognizing the operating status of each user of said user terminal devices;
recognizing the pictorial image of the user image-taken by image-taking means of each of said user terminal devices; and
changing said interuser distance in accordance with at least one result of recognition given by the input status of each user, the operating status of each user terminal device, and the user pictorial image image-taken by each image-taking means.

26. A method for controlling the display of a distributed system according to claim 15, further comprising the following step of:
inputting a designated interuser distance by the user operation, wherein
when said designated interuser distance is inputted, the interuser distance between said one of user terminal devices and said other user terminal device is controlled to be turned into said designated interuser distance.

27. A method for controlling the display of a distributed system according to claim 15, wherein said user status recognition is given either by said user terminal device or said server device.

28. A method for controlling the display of a distributed system according to claim 15, wherein said control is executed either by said user terminal device or said server device.

29. A storage medium having a program readable by a computer for structuring a distributed system by use of a plurality of user terminal devices having image-taking means and displaying means, and a server device connected with said plurality of user terminal devices through communication lines, wherein
said program is provided with user status recognition module for recognizing the status of user in use of said terminal devices per user terminal device; and control module for controlling the display of the user status on the other user terminal devices for said displaying means per user terminal device, and when the pictorial image of a user image-taken by image-taking means of the other user terminal device is displayed on one of the user terminal devices among each of said user terminal devices, said control module works out the interuser distance between said one of user terminal devices and said other user terminal device, and controls the display of the pictorial image of the user on said other user terminal device for said displaying means of said one of user terminal devices in accordance with said interuser distance thus worked out.

30. A storage medium according to claim 29, wherein said user status recognition module comprises input status recognition module for recognizing the status of input from each user of said user terminal devices; terminal operating status recognition module for recognizing the operating status of each of said user terminal devices; and image recognition module for recognizing the pictorial image of the user image-taken by image-taking means of each of said user terminal devices, and said controlling module changes said interuser distance in accordance with the user status of said one of user terminal devices obtained by at least one combination or more of the result of each recognition given by said input status recognition module, said terminal operating status recognition module, and said image recognition module.

31. A sever device connected with a plurality of user terminal devices through communication lines, comprising:
storage medium for storing the information for designating a plurality of virtual spaces to enable a user to reside therein, and the information for designating one specific virtual space among a plurality of virtual spaces to be set by said user;
signal receiving means for receiving the user information to be transmitted from one of said plurality of user terminal devices;
first signal distributing means for distributing the user information received by said signal receiving means to the other user terminal devices positioned in said specific virtual space set by the user of the user terminal device on the transmitting side of said user information; and
second signal distributing means for distributing the user information received by said signal receiving means to the other user terminal devices positioned in the virtual space other than said specific virtual space among a plurality of virtual spaces to enable the user of the user terminal device on the transmitted side of said user information to reside therein.

32. A server device according to claim 31, wherein said second signal distributing means distributes signals to the user terminal devices positioned in the virtual space other than said specific virtual space after the execution of a designated conversion of the user information received by said signal receiving means.

33. A server device according to claim 32, wherein said user information contains the pictorial image data regarding the user.

34. A server device according to claim 33, wherein said designated conversion is a conversion in order to curtail the amount of information of said pictorial image data.

35. A server device according to claim 31, wherein said user information contains message data prepared by the user arbitrarily.

36. A server device according to claim 32, wherein the user of the user terminal device on the transmitting side of said user information can designate the execution of the converted contents of said designated conversion by said second signal distributing means.

37. A server device according to claim 36, wherein said designation is made individually per virtual space other than said specific virtual space.

38. A user terminal device connected with a server device through communication line, comprising:
first signal transmitting means for transmitting to said server device the information for designating one specific virtual space set by said user among a plurality of virtual spaces for the user to reside therein;
acquiring means for acquiring the user information regarding said user;
second signal transmitting means for transmitting to said server device the user information acquired by said acquiring means; and
reception display means for receiving and displaying the other user information distributed by said server device.

39. A user terminal device according to claim 38, wherein said reception display means executes the designated conversion of the user information distributed from said server device for display in accordance with the instructions from said server device.

40. A virtual space system formed by a plurality of user terminal devices, and a server device connected with said plurality of user terminal devices through communication lines for structuring virtual spaces on a network comprising:
first signal transmitting means provided for each of the user terminal devices for transmitting to said server device the information for designating the one specific virtual space set by said user among a plurality of virtual spaces for enabling the corresponding user to reside therein;
acquiring means provided for each of the user terminal devices for acquiring the user information regarding the corresponding user;
second signal transmitting means provided for each of the user terminal devices for transmitting to said server device the user information acquired by corresponding acquiring means among said acquiring means;
storage means provided for said server device to store the information for designating a plurality of virtual spaces for a user to reside therein, and the information for designating said specific virtual space transmitted by said first transmitting means;
signal receiving means provided for said server device to receive the user information transmitted from said second transmitting means of said plurality of user terminal devices;
first signal distributing means provided for said server device to distribute the user information received by said signal receiving means to the other user terminal devices positioned in said specific virtual space set by the user of the user terminal device on the transmitting side of said user information;
second signal distributing means provided for said server device to distribute the user information received by said signal receiving means to the other user terminal device positioned in the virtual space other than said specific virtual space among a plurality of virtual spaces for enabling the user of the user terminal device on the transmitting side of said user information to reside therein; and
reception display means provided for each of the user terminal devices to receive and display the other user information distributed by said first signal distributing means or said second signal distributing means.

41. A virtual space system according to claim 40, wherein said second signal distrusting means distributes to the user terminal devices positioned in the virtual space other than said specific virtual space the user information received by said signal receiving means after the execution of designated conversion thereof.

42. A method for distributing user information applicable to the server device connected with a plurality of user terminal devices through communication lines comprising the following steps of:
storing the information to designate a plurality of virtual space for enabling the user to reside therein, and the information to designate the specific one of said plurality of virtual spaces set by said user;
receiving signals of the user information transmitted from said plurality of user terminal devices;
distributing firstly the signals of the user information received in said signal receiving step to the other user terminal device positioned in said designated virtual space set by the user of the terminal device on the transmitting side of said user information; and
distributing secondly the signals of the user information received in said signal receiving step to the other user terminal device positioned in the virtual space other than said designated virtual space among a plurality of virtual spaces for enabling the user of the terminal device on the transmitting side of said user information to reside therein.

43. A method for distributing user information according to claim 42, wherein the designated conversion is executed in the second signal distributing step for the user information received in said signal receiving step, and after that, the distribution is made to the user terminal devices positioned in the virtual space other than said specific virtual space.

44. A method for displaying user information applicable to the user terminal devices connected with a server device through communication lines, comprising the following steps of:
transmitting firstly the information for designating one specific virtual space set by a user among a plurality of virtual spaces to enable the user to reside therein;
acquiring the user information regarding said user;
transmitting secondly the user information acquired in said acquiring step to the server device; and
receiving and displaying the information of other users distributed form said server device.

45. A method for distributing and displaying user information applicable to a virtual space system formed by a plurality of user terminal devices and a server device connected with said plurality of user terminal device through communication lines for structuring virtual spaces within a network, comprising the following:
a first signal transmitting step for each terminal device to transmit to said server device the information for designating one specific virtual space set by a user concerned among a plurality of virtual spaces to enable the corresponding user to reside therein;
an acquiring step for each user terminal device to acquire user information regarding the corresponding user;
a second transmitting step for each user terminal device to transmit the user information acquired in said acquiring step to said server device;
a storing step for said server device to store the information for designating a plurality of virtual spaces to enable a user to reside therein, and the information for designating said specific virtual space transmitted in said first signal transmitting step;
a signal receiving step for said server device to receive the user information transmitted from said plurality of user terminal devices in said second transmitting step;
a first signal distributing step for said server device to distribute the user information received in said signal receiving step to the other user terminal devices positioned in said specific virtual space set by the user of the user terminal device on the transmitting side of said user information;
a second signal distributing step for said server device to distribute the user information received in said signal receiving step to the other user terminal devices positioned in the virtual space other than said specific space among a plurality of virtual spaces for enabling the user of the user terminal device on the transmitting side of said user information to reside therein; and
a receiving and displaying step for each user terminal device to receive and display the information of other user distributed in said first signal distributing step or said second signal distributing step.

46. A method for distributing and displaying user information according to claim 45, wherein said second signal distributing step executes the designated conversion for the user information received in said signal receiving step, and after that, makes the distribution thereof to the user terminal devices positioned in the virtual space other than said specific virtual space.

47. A storage medium readable by a computer for storing a method for distributing user information as a program applicable to the server device connected with a plurality of user terminal device through communication lines, wherein
said method for distributing user information comprises:
a storing step for storing the information for designating a plurality of virtual spaces for enabling a user to reside therein, and the information for designating the specific one virtual space set by said user among said plurality of virtual spaces;
a signal receiving step to receive the user information transmitted from said plurality of user terminal devices;
a first signal distributing step to distribute the user information received in said signal receiving step to the other user terminal devices positioned in said specific virtual space set by the user of the user terminal device on the transmitting side of said user information; and
a second signal distributing step to distribute the user information received in said signal receiving step to the other user terminal devices positioned in the virtual space other than said specific virtual space among a plurality of virtual spaces for enabling the user of the user terminal device on the transmitting side of said user information to reside therein.

48. A storage medium according to claim 47, wherein said second signal distributing step executes the designated conversion for the user information received in said signal receiving step, and after that, the distribution thereof is made to the user terminal devices positioned in the virtual space other than said specific virtual space.

49. A storage medium readable by a computer for storing a method for displaying user information as a program applicable to the user terminal devices connected with a server device through communication lines, wherein
said method for displaying user information comprises:
a first signal transmitting step for each user terminal device to transmit to said server device the information for designating the specific one virtual space set by a user concerned among a plurality of virtual space for enabling said user to reside therein;
an acquiring step for acquiring the user information regarding said user;
a second signal transmitting step for transmitting the user information acquired in said acquiring step to said server device; and
a displaying step for receiving and displaying the other user information distributed from said server device.

50. A storage medium readable by a computer for storing a method for distributing and displaying user information as a program applicable to the user terminal devices connected with a server device through communication lines, wherein
said method for distributing and displaying user information comprises:
a first signal transmitting step for transmitting to said server device the information for designating the specific one virtual space set by a user concerned among a plurality of virtual space for enabling said user to reside therein;
an acquiring step for each user terminal device to acquire the user information regarding said user;
a second signal transmitting step for each user terminal device to transmit to said server device the user information acquired in said acquiring step to said server device; and
a storing step for said server device to store the information for designating a plurality of virtual spaces enabling the user to reside therein, and the information for designating said specific virtual space transmitted in said first signal transmitting step;
a signal receiving step for said server device to receive the user information transmitted from said plurality of user terminal devices in said second transmitting step;
a first signal distributing step for said server device to distribute the user information received in said signal receiving step to the other user terminal devices positioned in said specific virtual space set by the user of user terminal device on the transmitting side of said user information;
a second signal distributing step for said server device to distribute the user information received in said signal receiving step to the other user terminal devices positioned in the virtual space other than said specific virtual space among a plurality of virtual spaces for enabling the user of the user terminal device on the transmitting side of said user information; and
a receiving and displaying step for each terminal device to receive and display the other user information distributed in said first signal distributing step or said second signal distributing step.

51. A storage medium according to claim 50, wherein said second signal distributing step executes the designated conversion of the other user information received in said signal receiving step, and after that, the distribution thereof is made to the user terminal devices positioned in the virtual space other than said specific virtual device.
a displaying step for receiving and displaying the other user information distributed from said server device.
